(19) United States
(12) Patent Application Publication
(10) Pub. No.: US 2023/0043483 A1
(43) Pub. Date: Feb. 9, 2023

(54) HIGH-LEVEL MULTIPLEXING REACTION VESSEL, REAGENT SPOTTING DEVICE AND ASSOCIATED METHODS

(71) Applicant: Cepheld, Sunnyvale, CA (US)

(72) Inventors: Jennifer Lynn Glass, San Jose, CA (US); Michael Quay Chen, Palo Alto, CA (US); John Benjamin Dority, Corner, GA (US); Jonathan Philip Siegrist, San Jose, CA (US); Joanna Wong, San Jose, CA (US)

(21) Appl. No.: 17/811,448

(22) Filed: Jul. 8, 2022

Related U.S. Application Data
(60) Provisional application No. 63/220,277, filed on Jul. 9, 2021.

(51) Int. Cl. B01L 3/00

(52) U.S. Cl. CPC B01L 3/502715; B01L 2200/027; B01L 2200/16; B01L 2300/0829; B01L 2300/0883; B01L 2400/0633; B01L 2300/0654

(57) ABSTRACT

Reaction vessels, cartridges, devices and methods for facilitating high-level multiplexing are described herein. Such reaction vessels can include a planar frame defining a fluidic path between a first planar substrate and a second planar substrate, a fluidic interface is located at one end of the planar frame with a pair of fluidic ports, a well chamber and a pre-amplification chamber. Devices for spotting reagents in wells of high-level multiplexing reaction vessels and improved reagent solutions are also described herein.

### REFERENCES TO RELATED APPLICATIONS

This application is a Non-Provisional of and claims the benefit of priority of U.S. Provisional Application No. 63/220,277 filed on Jul. 9, 2021, which is incorporated herein by reference in its entirety.

### BACKGROUND OF THE INVENTION

It can be desirable to perform a plurality of assays simultaneously to provide varied and large data sets. Such a process is often referred to as a “multiplexing assay.” Thus, there is a need for reaction vessels, devices and methods that can perform high-level multiplexing assays.

### BRIEF SUMMARY OF THE INVENTION

Some embodiments of the invention relate to a reaction vessel having a planar frame defining a fluidic path between a first planar substrate and a second planar substrate, a fluidic interface is located at one end of the planar frame and include first and second fluidic ports in fluidic communication with the fluidic path. The fluidic path extends between the first and second fluidic ports of the fluidic interface. The fluidic path further includes a well chamber configured with a plurality of wells and a pre-amplification chamber. The plurality of wells of the well chamber can be any of various types of wells, for example wells of various sizes (e.g. nano-wells, microwells, or any desired size) and wells of various shapes (e.g. rounded, square, rectangular, polygonal, etc.).

In some embodiments, the pre-amplification chamber is disposed along the fluidic path between the second fluid port and the well chamber, and the well chamber is disposed along the fluidic path between the pre-amplification chamber and the first fluidic port. In other embodiments, the pre-amplification chamber is disposed along the fluidic path between the first fluid port and the well chamber, and the well chamber is disposed along the fluidic path between the pre-amplification chamber and the second fluidic port.

In some embodiments, a pre-amplification chamber exit is separated from the well chamber by a serpentine passage of the fluidic path. In some embodiments, the fluidic path is fluidically connected to an oil trap chamber between the serpentine passage and the well chamber. In some embodiments, the oil trap chamber is coupled to the fluidic path via an oil trap valve structure. In some embodiments, the fluidic path includes another valve structure fluidically connecting the serpentine path to the well chamber exit passage. In any of the embodiments here, the valves can be a passive valve, such as a constriction that is integrally formed with the fluidic path. In some embodiments, the valve can be an active valve structure, and include additional movable components or films.

In some embodiments, the well chamber includes a well chamber entrance that is positioned at a lower-most portion of the well chamber when the first and second planar substrates are vertically oriented. In some embodiments, the first fluidic port is fluidically coupled to a substantially horizontal inlet passage that connects to the well chamber entrance which slopes upward into the well chamber.

In some embodiments, the second fluidic port is connected to the pre-amp passage by a substantially vertical pre-amp passage that connected to a substantially horizontal pre-amp entrance which fluidically connected to the bottom of the pre-amplification chamber.

In some embodiments, the well-substrate can have a plurality of about 100 to about 1500 nanowells. In some embodiments, the well-substrate comprises a plurality of wells having a diameter of about 50 to about 500 μm. In some embodiments, the well-substrate can have a plurality of nanowells each having a depth of about 100 μm.

In some embodiments, the well-substrate can have a plurality of nanowells where each well of the plurality of nanowells can range in depth from about 25 μm to about 1000 μm.

In some embodiments, the well-substrate can have a plurality of nanowells wherein each well of the plurality of nanowells has a width in the range from about 25 μm to about 500 um.

In some embodiments, each well of the plurality of wells can have a volume in the range of about 0.1 nL to about 500 nL. In some embodiments, each well of the plurality of wells has a volume in the range of about 0.5 nL to about 1.5 nL. In some embodiments, each well of the plurality of wells has a volume in the range of about 1.2 nL.

In some embodiments, the fluidic path includes a serpentine channel between the pre-amplification chamber and the well chamber. The serpentine channel can include a series of segments that each curve by at least 180 degrees between segment. In some embodiments, the serpentine channel includes three or more such segments.

In some embodiments, the fluidic path is connected to an oil trap chamber between the pre-amplification chamber and the well chamber so as to trap any oil flowing from the pre-amplification chamber toward the well chamber.

In some embodiments, the planar frame can be fluidically connected to a sample container via the fluidic interface. In some embodiments, the planar frame can be a scaffold extending from a base portion. In some embodiments, the base portion includes a flange for mechanically and fluidically coupling to a sample container, such as a sample cartridge.

In some embodiments, the first and second planar substrates can have first and second films that fluidically seal the scaffold. In some embodiments, the first planar substrate is a film that sealed over the planar frame, while the second substrate is integrally formed with the planar frame.

In some embodiments, the plurality of wells can contain at least one nucleic acid primer and/or probe for amplification and/or detection of a specific target. In some embodiments, the plurality of wells can contain a molecule, e.g., an antibody, for the detection of a specific protein target.

Some embodiments of the invention relate to a method for providing a sample fluid to a fluidic interface of a reaction vessel. The reaction vessel can have a planar frame defining a fluidic path between a first planar substrate and a second planar substrate. A pre-amplification chamber can be filled where the fluid sample undergoes an amplification step in the pre-amplification chamber before filling the well chamber. A well-chamber of the fluidic path can be filled with a sample fluid, which comprises a sample material to be analyzed and may further comprise one or more chemicals for carrying out a multiplex assay, such that a plurality of wells in the well chamber are filled with the sample fluid. The sample fluid can then be evacuated from the well chamber such that the plurality of wells remains at least partially filled with the sample fluid. In some embodiments, heating and/or cooling cycles are applied to one or both of the first and second planar substrates.

Some embodiments of the invention relate to carrying out a multiplex amplification reaction in the reaction vessel. In some embodiments, the multiplex reaction involves a nested PCR. In some embodiments, the multiplex reaction is monitored using fluorescent indicators to indicate the presence of an amplicon. In some embodiments, the presence of an amplicon is detected using melt-curve analysis. In some embodiments, the multiplex reaction detects the presence or absence of at least one single nucleotide polymorphism (SNP). In some embodiments, the sample material used in a multiplex reaction is a body fluid or is derived from a body fluid. In some embodiments, the sample material is a tissue sample, or is derived from a tissue sample. In some embodiments, a multiplex reaction detects the presence or absence of a protein target. In some embodiments, a multiplex reaction detects the presence or absence of a nucleic acid. The nucleic acid can be DNA, RNA, or microRNA.

In another aspect, the invention pertains to a device and methods for spotting reagents in the wells of the reaction vessel. The device can include a bundle of capillary tubes configured for spotting individual wells of the array. In one aspect, the capillary tubes can be glass. The capillary tubes can be drawn out such that distal portions of tubes have a reduced diameter less than the width of the well. The tubes can be fixed within a spatial arrangement of the bundle that corresponds to the arrangement of the wells of the reaction vessel. Methods of spotting includes filling the capillary tubes by capillary action and depositing spots of reagent solution in the wells by surface contact tension. The device can include a relatively large number of capillary tubes, such as between about 25 and about 100 tubes, so as to facilitate more efficient spotting of the wells by positioning the device at various locations on the array. This approach can further be utilized to spot a pattern of differing reagents at differing locations on the array, thereby allowing for detection of multiple target analytes.

The capillary tubes of the capillary-pack (“cap-pack”) can be formed by pulling heating glass capillary tubes to create micropipettes and then assembled into a bundle within the capillary-pack. The capillary-pack can be filled simply by placing the capillaries into contact with the solution, and then can be dispensed by similarly contacting the capillaries into the wells and allowing capillary action/surface tension to spot the wells. In some embodiments, the pressure within the capillaries can be controlled from the proximal end to facilitate loading of the solution into the capillaries and dispensing of the solution into the wells. In some embodiments, the spotting system utilizes multiple capillary-packs so that multiple reaction vessels can be spotted simultaneously.

In another aspect, the invention pertains to improved reagent matrix solutions that are designed specifically for the methods of filling and performing PCRs with the reaction vessel described herein. In some embodiments, the reagent solution includes a matrix material having delayed water solubility so as to retain the reagent during filling of the wells and to facilitate release of the reagents after isolation of the wells. Such matrix can include a polymer or cellulose material. In some embodiments, the matrix material cross-links when heated such that heating the reaction improves the integrity of the solid form of the matrix and prolongs the delayed solubility during filing of the well. Such matrix material can include, but are not limited to, HEC (Hydroxyethyl cellulose), NIPAM (n-isopropylacrylamide) and Hydroxypropyl cellulose (HPC) at various concentrations and mixtures thereof.

### BRIEF DESCRIPTION OF THE DRAWINGS

FIGS. 1A-1C show various views of a reaction vessel, according to some embodiments of the invention.

FIGS. 1D and 1E show side views of alternative embodiments of a reaction vessel.

FIGS. 2A-2F show cross-sections of portions of the reaction vessel to show various embodiments of the well-substrate 120, according to some embodiments.

FIG. 3A show a method for providing the well-substrate 120 with primer material, according to some embodiments.

FIG. 3B shows pulled glass capillary tubes for use in spotting reagents in the wells of the reaction vessel, according to some embodiments.

FIG. 3C shows manual spotting of reagents with a pulled glass capillary, according to some embodiments.

FIG. 3D shows a capillary-pack device having a bundle of pulled capillary tubes for spotting of reagents in wells of a reaction vessel, according to some embodiments.

FIG. 3E shows an x-y-z robotic positioning device for use in positioning one or more capillary-pack devices to spot multiple reaction vessels simultaneously, according to some embodiments.

FIG. 3F shows a methodology of spotting reagents in wells of a reaction vessel with a capillary-pack device, according to some embodiments.

FIGS. 4A-4E show various methods for filling a well-substrate with a sample fluid, according to some embodiments.

FIGS. 5A-5G show various sensor assemblies positions in relation to a reaction vessel, according to some embodiments.

FIG. 6 shows a fluid control and processing system for providing a sample fluid to a reaction vessel, according to some embodiments.

FIG. 7 shows a PCR testing system having multiple modules, each receiving a sample cartridges having a reaction vessel, in accordance with some embodiments.

FIG. 8 shows a PCR testing module removed from the system enclosure, in accordance with some embodiments.

FIG. 9A shows an exploded view of an instrument core assembly of a module, in accordance with some embodiments.

FIG. 9B shows a sample cartridge with attached reaction vessel interface with components of the instrument core assembly, in accordance with some embodiments.

FIGS. 10A-10B show photos of experiments demonstrating testing with a well array of a reaction vessel, in accordance with some embodiments.

FIGS. 11A-11B depicts analytical testing for detection of multiple targets of a cancer panel, in accordance with some embodiments.

FIGS. 12-13 show a comparison of the analytical testing for multiple targets between a bulk-fill array and an array spotted in accordance with some embodiments.

FIG. 14 show an example of a reagent spotting pattern for analytical testing of multiple targets of a cancer panel, in accordance with some embodiments.

FIG. 15 show an example of results from a spotted array in analytical testing of multiple targets of a flu panel, in accordance with some embodiments.

FIG. 16 show a comparison of inhibition test results from unspotted (bulk) wells and well spotted in accordance with some embodiments.

FIGS. 17-22 show performance results from experimentation of reagent matrix materials under various conditions, in accordance with some embodiments.

### DETAILED DESCRIPTION OF THE INVENTION

In one aspect, the invention pertains to reaction vessels, devices, systems, and associated methods of use and manufacture to facilitate high-level multiplexing assays. In conventional devices utilizing sample preparation cartridges, such as the GeneXpert® system from Cepheid, a planar reaction vessel is utilized to perform a PCR reaction and detection of a target analyte. However, current reaction vessels utilize a single reaction chamber, which limits the number of target analytes that can be analyzed, as compared to analytical systems utilizing microarrays with high-level multiplexing. While some multi-well designs of reaction vessels have been developed, such as that described in U.S. Pat. No. 9,914,968, there remain a number of challenges in performing high-level multiplexing, particularly as to amplifying the sample before PCR and in providing consistent, uniform filling of the wells. Therefore, there is a need for reaction vessels that further improve upon these aspects in regard to filling and analytical testing, and accordingly, improvements of the associated sample cartridges, processing modules and associated filling and reagent spotting technologies to facilitate high-level multiplexing.

Developments of the present invention provide a complete system by which highly spatially multiplexed PCR CE/IVD molecular diagnostic assays can be performed. The system includes at least a sample test cartridge with attached reaction vessel, instrument hardware, and associated software. Application for assays developed with such system can include highly multiplexed infectious disease panels and multigene assays for oncology.

The improved reaction vessel and associated methods are particularly advantageous as they are compatible with existing sample cartridge devices and can therefore expand testing capabilities in existing systems. This allows the high-level multiplexing to be performed within the same existing system (with some modification of the system hardware/software) so that that the entire range of assays available can be performed by the same instrument. Since the same cartridge device is used, the sample preparation procedures can remain the same as that of existing systems. The advantages of higher-level multiplexing includes higher confidence levels for detection of the target analytes, and further allows for detection of more target analytes by the same reaction vessel, which opens the door to performing a panel of tests, such as a flu panel, or more oncology-focused panels (e.g., breast cancer signature panel). Further, the high-level multiplexing reaction vessels utilizes a higher density well array, which benefits from improved reagent spotting device and techniques that may also have applicability to various microarray designs as well.

I. Reaction Vessel Construction

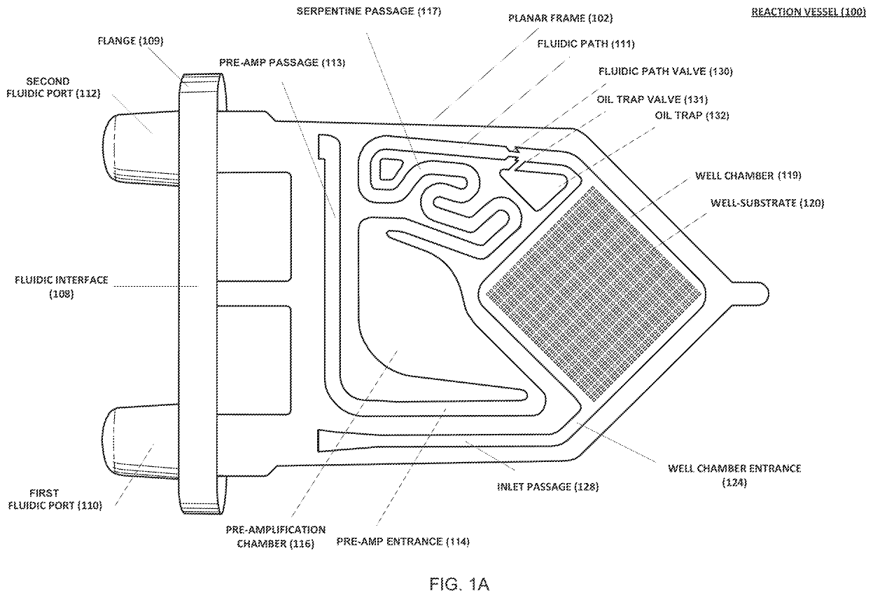

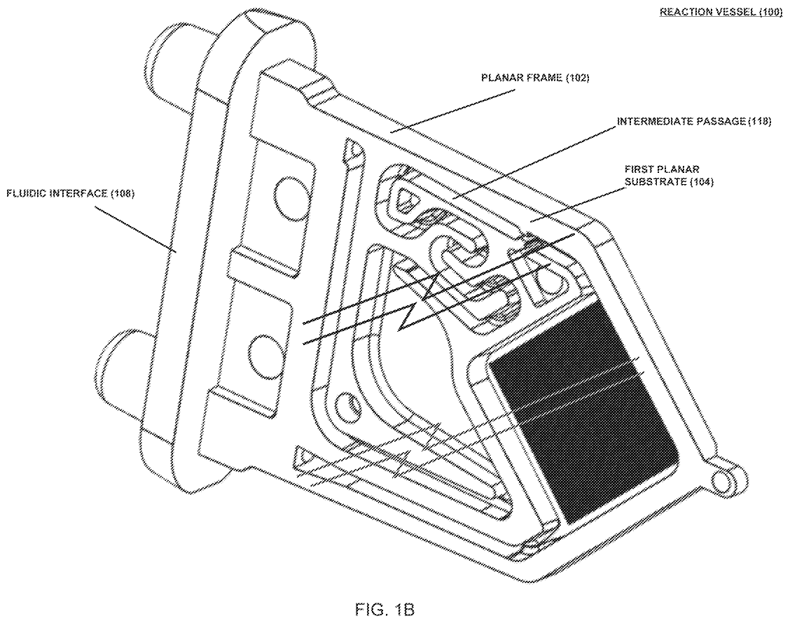

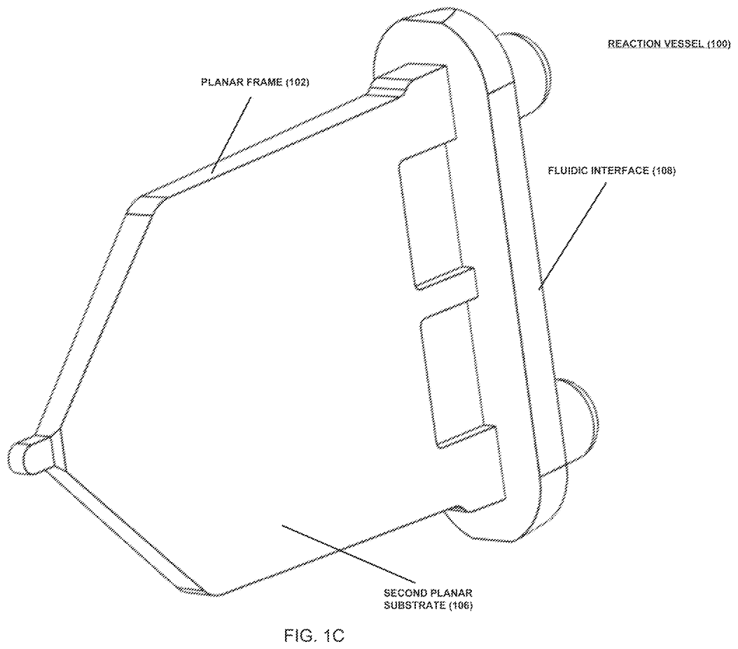

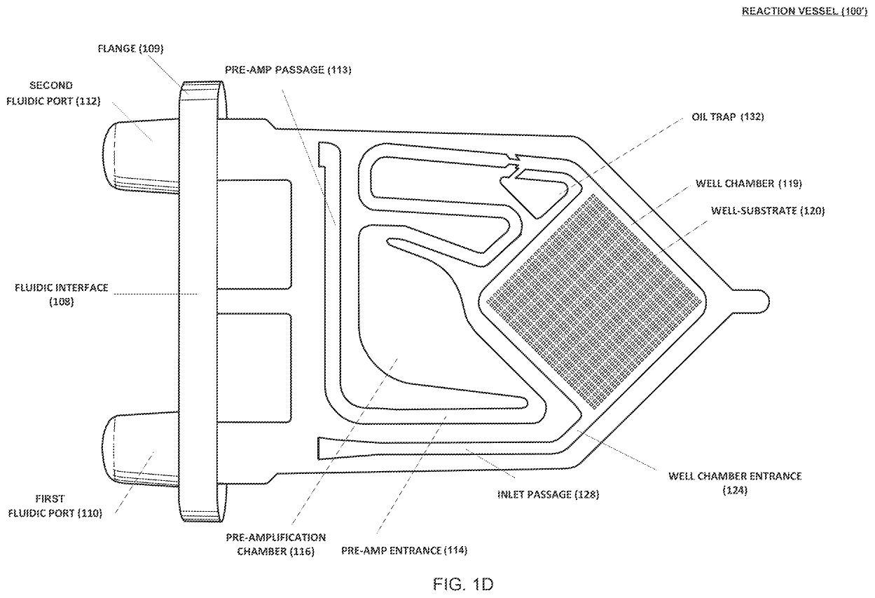

FIG. 1A-1C depicts an exemplary reaction vessel 100. The reaction vessel 100 includes a planar frame 102, which in some embodiments is a truss-like structure that is formed from polymer (e.g., polypropylene/acrylic substrate) or metal material that is generally PCR compatible. The planar frame 102 can be formed as an open truss or scaffold, bounded on the open sides by a first planar substrate 104 and a second planar substrate 106.

As shown in FIGS. 1B-1C, the second planar substrate 106 is integrally formed with the planar frame 102 and the first planar substrate 104 can be formed from a relatively thin polymer film that is adhered or otherwise bonded to the planar frame 102. In some embodiments, the first and second planar substrates can be polymer films that are bonded to opposite sides of a planar frame. In some embodiments, all or portions of one of the first planar substrate 104 and second planar substrate 106 can be integrally formed with the planar frame 102 (e.g., by 3-D printing, molding, co-molding, or machining one of the substrates with the planar frame 102). In some embodiments, the first planar substrate 104 and second planar substrate 106 and integral frame are constructed from a transparent material, which is depicted here. In some embodiments, at least a portion of the reaction vessel is transparent. Each of the first planar substrate 104 and second planar substrate 106 include interior and exterior facing surfaces. These interior facing surfaces form fluidic passageways with interior cavities of the planar frame 102.

One portion of the planar frame 102 forms a fluidic interface 108. The fluidic interface 108 is a structural member which a majority of the planar frame 102 cantilevers. The fluidic interface 108 can be integrally formed with the planar frame 102. The fluidic interface 108 also serves as a mechanical coupling to a cartridge device, for example by engagement with flange 109. The fluidic interface 108 includes a first fluidic port 110 and a second fluidic port 112, which provide fluidic interfaces to the cartridge device or sample container for passage of fluid therethrough. A fluidic path 111 that is formed in the planar frame 102 between the first planar substrate 104 and second planar substrate 106 extends between the first and second fluidic ports. It is understood that the term “fluidic path” refers to the entire fluidic path between the fluidic ports and that the fluidic path can include one or more features (e.g. valves, chambers, passages) defined therein. It should be understood that use of the terms “first fluidic port” and “second fluidic port” does not limit function of the respective ports and that fluid can be introduced and evacuated from both or either port.

The fluidic path 111 includes one or more chambers for processing or testing of the fluid sample introduced therein. In some embodiments, the fluidic path 111 can include one or more valves, which can be constrictions, such that air can still move relatively freely, while passage of fluids may be more restricted through the valves so that external increases or decreases in pressures can be applied via the fluidic inlet port 110 and fluidic outlet port 112 by an external system to move fluid within the fluidic path 111, which extends from the fluidic inlet (110) to the fluidic outlet (112). In other embodiments, the fluidic path 111 is valveless.

In one aspect, the fluidic path 111 includes a well chamber 119. The well chamber 119 holds a well-substrate 120 having a plurality of wells (also referred to herein as microwells, nanowells or nanowell array). The well-substrate 120 is integrally formed with the first planar substrate 104 and planar frame 102. In some embodiments, the well-substrate can be separately formed and placed within the well-chamber. In other embodiments, the well-substrate 120 can be constructed from a metal, (e.g., gold, platinum, or nickel alloy), ceramic, or other PCR compatible polymer material, or a composite material. In some embodiments, the well-substrate 120 can include any number of wells, for example, 50-1500 wells, or more. As shown here, the well-substrate is defined as a well array having 1024 individual wells in a 32 by 32 array.

In some embodiments, the wells are integrally formed with the second planar substrate 106 and planar frame 102 (e.g., by molding). In other embodiment, the wells can be formed by forming indentions within the molded second substrate. In still other embodiments, the wells can be formed in a well-substrate 120 as blind-holes or through-holes. The wells can be created within a well-substrate 120, for example, by laser drilling (e.g., excimer or solid-state laser), ultrasonic embossing, hot embossing lithography, electroforming a nickel mold, injection molding, and injection compression molding.

In some embodiments individual well volume can range from about 0.1 to about 1500 nL, about 0.5 to about 200 nL, about 0.5 to about 50 nL, about 0.8, about 1.6 nL, or more preferably about 1.2 nL. The well dimensions can have any shape, for example, circular, elliptical, square, rectangular, ovoid, hexagonal, octagonal, and other shapes well known to persons of skill in the art. In this embodiment, the wells are square, with the width being greater than the depth. Here, the wells are approximately 175 um×175 um by 85 um deep. In other embodiments, the well diameter and depths can be equal or the depth can be greater than the width. Well dimensions can be derived from the total volume capacity of the well-substrate 120. In some embodiments, well depths can range from about 25 μm to about 1000 μm. In some embodiments, well diameter can range from about 25 μm to about 500 μm.

The wells of the well-substrate 120 can be patterned to have a simple geometric pattern of aligned rows and columns, or patterns arranged diagonally or hexagonally. In some embodiments, the wells of the well-substrate 120 can be patterned to have complex geometric patterns, such as chaotic patterns or isogeometric design patterns as described by Schillinger et al., Computer Methods in Applied Mechanics and Engineering Jan. 22, 2012. The wells can be geometrically separated from one another and/or feature large depth to width ratios to help prevent cross-contamination of reagents during the filling process.

In another aspect, the fluidic path can include a pre-amplification chamber 116 that is sized to accommodate the fluid sample. In this embodiment, the pre-amplification chamber (also known as “pre-PCR chamber”) is about 30 uL in volume. This volume can accommodate the fluid sample and also an oil cap (e.g. a light oil, mineral oil) introduced before the fluid sample to isolate the fluid sample during pre-amplification. The pre-amplification chamber is fluidically coupled to the second fluidic port 112 through the pre-amp passage 113 and the pre-amp entrance passage 114 so that the pre-amplification chamber is filled through introduction of fluid sample through the second fluidic port 112. Beyond the pre-amplification chamber 116 is a serpentine passage 117 that includes multiple segments that wind in differing direction in a serpentine fashion. In this embodiment, the serpentine passage includes a series of segments having bends of 180 degrees or greater between segments. The serpentine flow path mitigates vapor transmission and mitigates light oil wicking along the fluidic path. The minimum oil volume is determined by cross-sectional area of the fluidic path. Pre-amplification (pre-PCR) is utilized in order to ensure ≥1 target DNA strand is deposited in each well when the amplified fluid sample fills the well chamber. At target concentrations less than ˜10 copies per well, statistically a significant number of wells contain zero target copies. For robustness, 25-50 copies per well is recommended. In some embodiments, pre-PCR volume must account for the following: standard elution volumes (40-60 μL) and efficiency of elution, bead target volume (80 μL), amplicon contamination limits (≤25 cycles), dilution of product from 1:5 to 1:20 to remove pre-amp enzyme and primers, 50 μL Pre-PCR is ideal, based on the above factors.

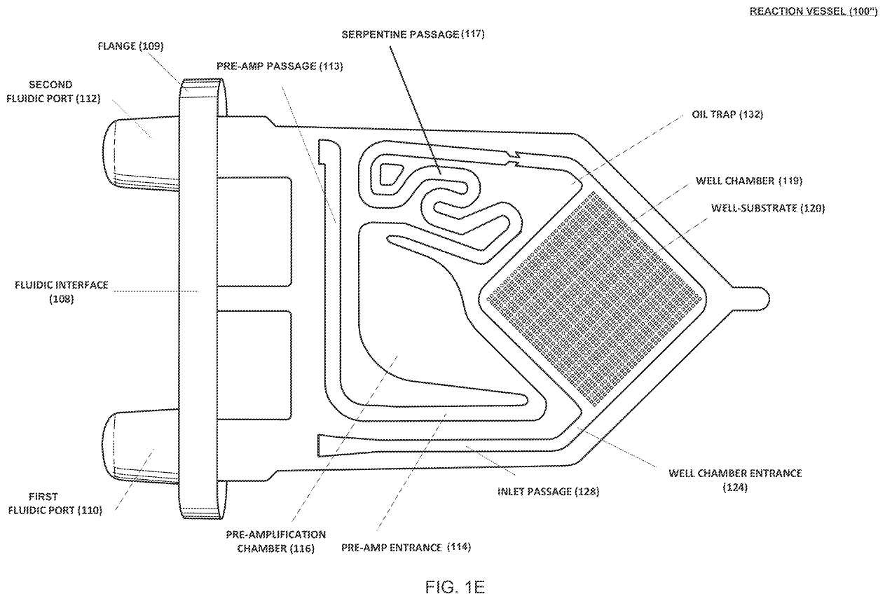

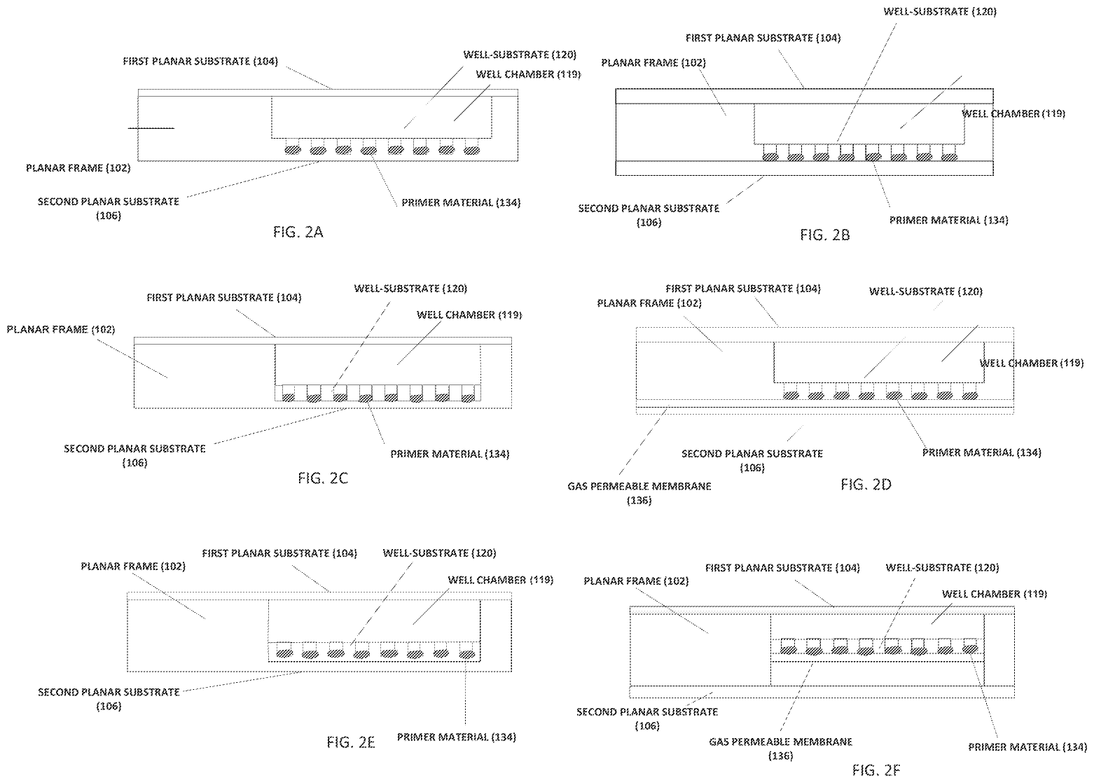

As shown in FIGS. 1B and 2A, the first planar substrate 104 can be a thin film that is sealed over the second planar substrate 106 such that a gap is formed (so as to allow fluid to pass) between second planar substrate and the first planar substrate thereby forming the fluidic channel, as well as the well chamber and the pre-amplification chamber. The pre-amplification chamber 116 includes a pre-amplification chamber entrance at the bottom-most portion and an exit located at the upper-most portion of the pre-amplification chamber 116 (in the vertical orientation shown). Beyond the pre-amplification chamber exit is the serpentine passage which leads to a down-ward sloping intermediate passage 118 that is fluidically coupled to a well chamber exit at the top of the well chamber. The intermediate passage 118 includes a fluidic path valve 130 and is in fluidic communication with an oil trap 132 via an oil trap valve 131. In this embodiment, the valves are configured as constructions to allow free flow of air therethrough, however, it is appreciated that any suitable valve construction can be used. This arrangement of the pre-amplification chamber allows for a sufficient volume of fluid-sample to be amplified so as to obtain sufficient copies of DNA before the fluid sample fills the wells of the well chamber to ensure each well receives a copy. By including the pre-amplification chamber and the well chamber along the same fluidic path between two fluidic openings of the fluidic interface, the fluid sample can be transported into the pre-amplification chamber and withdrawn into the sample cartridge, then subsequently transported into the well chamber and excess fluid sample can be withdrawn. All this fluid transport can be affected by varying application of pressure at one or both of the fluidic ports of the fluidic interface. During pre-amplification, the fluid sample can be thermally cycled, during which the DNA copies within the fluid sample multiply. The serpentine channel acts to inhibit flow of excess fluid sample and/or associated moisture from the fluid sample beyond the pre-amplification chamber into the well chamber. In this embodiment, a cap of light oil can additionally be injected before introduction of the fluid sample such that the oil cap floats on the fluid sample during amplification. The oil trap acts to contain any excess oil that might flow beyond the serpentine passage and into the intermediate channel, so as to prevent fouling of any wells within the well chamber.

In regard to the number and size of wells of the well array, assuming 10 copies of input DNA, 1:10 dilution of Pre-PCR product, 80 μL bead size, 100% PCR efficiency, and >25 copies of final PCR target/well, it was determined that: 0.5 nL well volumes requires 22 pre-PCR cycles to achieve >25 copies of the PCR target; 1 nL wells required 21 cycles; 2 nL wells required 20 cycles; and 5 nL cycles requires 19 cycles. In some embodiments, 10 nL wells are well suited for reducing PCR cycles, however, pre-PCR volume+(10 nL×1000) wells will not fit within the reduced area of the reaction vessel. Wells of about 1 nL (in particular 1.2 nL) only require 3 more pre-PCR cycles, so a 32×32 square array (1024 wells) of 1.2 nL volume is advantageous as the well array can fit within the confines of the reduced area of the reaction vessel.

FIGS. 1D and 1E show alternative designs of the reaction vessels. The design in FIG. 1D is substantially similar to that in FIG. 1A except without the serpentine channel. The design in FIG. 1E is substantially similar to the design in FIG. 1A except without the oil trap and oil trap valve. It is appreciated that various other reaction vessel designs and modification can be realized.

FIGS. 2A-2F show cross-sections of portions of the reaction vessel to show various embodiments of the well-substrate 120.

FIG. 2A shows an embodiment where wells of the well-substrate 120 are constructed as indentions made into the second planar substrate 106. In this embodiment, the second planar substrate 106 is integrally formed with the planar frame 102, such that they are essentially one piece of material. Typically, the chambers and channels/passages are features within a mold such that injection molding forms the entire frame and first substrate are integrally formed. In some embodiments, the wells are formed as features within mold. In some embodiments, the wells are formed by indentions made within the well chamber. Primer/probe materials 134 are subsequently placed into each well of the well chamber by reagent spotting techniques. Primer material 134 comprises primer(s), probe(s), and/or matrix material(s). It is appreciated that the reaction vessel fabrication is not limited to this fabrication approach, for example, various other approaches to well formation are depicted in the alternative embodiments in FIGS. 2B-2C.

FIG. 2B shows an embodiment where wells of the well-substrate 120 are constructed via through-holes made into a substrate, such as a polymer film, that is bonded onto the planar frame 102. For example, a separate substrate can be drilled to form a well-substrate of through holes, and subsequently adhered or welded onto the planar frame 102. In this embodiment, the second planar substrate 106 is integrally formed with the planar frame 102, such that they are essentially one piece of material. Alternatively, blind holes can be formed within the second planar substrate 106, which can be bonded onto the planar frame 102.

FIG. 2C shows an embodiment where wells of the well-substrate 120 are constructed via through-holes formed within a portion of the planar frame 102. In this embodiment, the second planar substrate 106 is integrated with the planar frame 102 and the well-substrate 120 is a separate component that is adhered or welded to a pocket within the planar frame 102.

FIG. 2D shows an embodiment where wells of the well-substrate 120 are constructed via through-holes formed within a portion of the planar frame 102, as shown in FIG. 2C. However, in this embodiment, a gas permeable membrane 136 is located between the planar frame 102 and the second planar substrate 106. The membrane 136 enables gas to be evacuated from the wells through the membrane, while not allowing fluid to pass through. The gas permeable membrane can be adhered to the well-substrate by a gas permeable adhesive.

FIG. 2E shows an embodiment where wells of the well-substrate 120 are constructed via blind-holes formed within a portion of the planar frame 102. In this embodiment, the second planar substrate 106 is integrated with the planar frame 102 and the well-substrate 120 is a separate component that is adhered or welded to a pocket within the planar frame 102.

All or portions of the well-substrate 120 can contain conductive metal portions (e.g., gold) to enable heat transfer from the metal to the wells. For example, the portion of the well-substrate 120 that is placed against the second planar substrate 106 can be a metal plate or coating. Alternatively, interior surfaces of the wells can be coated with a metal to enable heat transfer.

FIG. 2F shows an embodiment that is constructed similarly to the embodiment of FIG. 2D. However, here the well-substrate is positioned a mid-point between the first and second substrates. The gas permeable membrane 136 can be adhered to the well-substrate by a gas permeable adhesive. As with the embodiment shown in FIG. 2D, air can exit through the gas permeable membrane to the back of the wells during liquid filling. After PCR buffer is filled individual well and rehydrates the dried primer sets in the well, an isolation oil or thermally conductive liquid can fill both sides of the wells to prevent cross-talk.

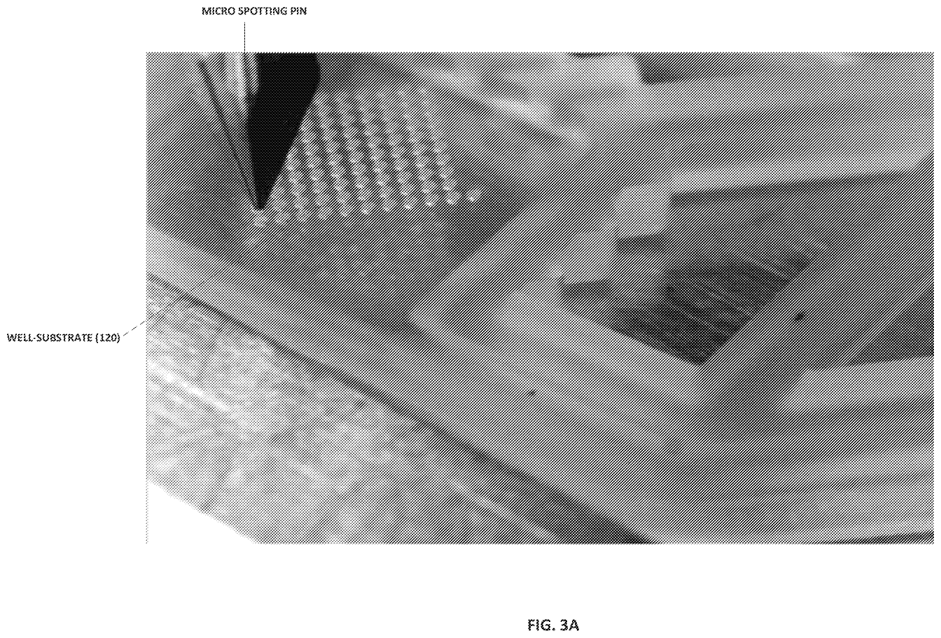

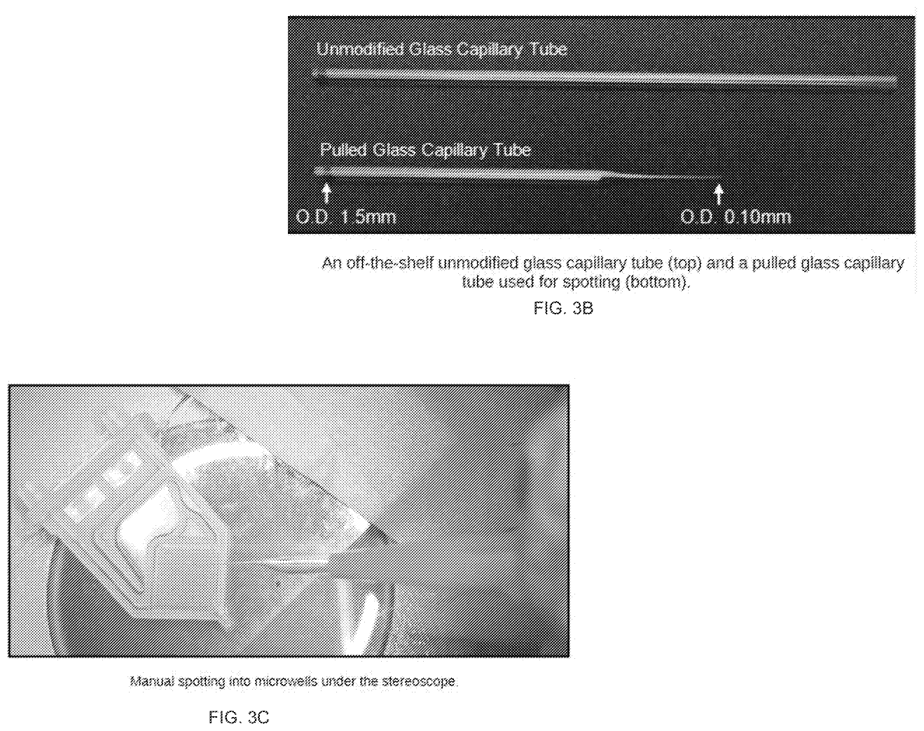

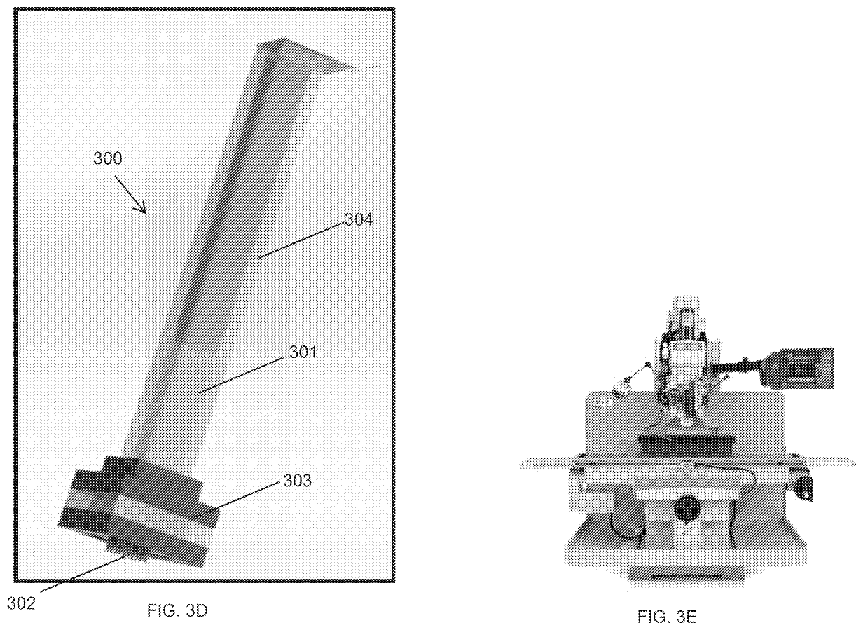

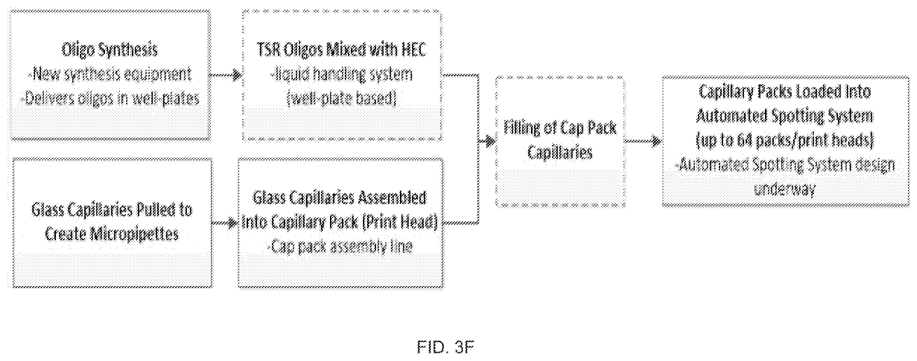

FIG. 3A shows a method for providing the well-substrate 120 with reagent solution, such as a primer material. As shown, a commercially available printing pin can be used to fill the wells with a liquid primer, which can be dried in the well or the liquid filled well can be sealed-over after filling. In some embodiments, after the well-substrate 120 is provided with primer in a liquid form, the primer material can be dried such that only a primer residue remains adhering to each well for later liquefaction. Examples of such pins (and associated systems) include the 946MP(x) series of pins from ArrayIt Corporation, located at 524 East Weddell Drive, Sunnyvale, Calif. 94089, USA. Methods disclosed by Hasan et al., U.S. Pub. No. 2009/0054266 and Hess et al., U.S. Pat. No. 6,716,629, can also be used to provide primer material. During the application process, the printing pin can be configured to make contact with the well-substrate 120. Alternatively, a non-contact process can be used using the printing pin, for example a droplet-based method such as ink-jet printing, or other suitable non-contact processes known to persons of skill in the art. It is appreciated that this is but one example of spotting primers/reagents within the wells and that various other techniques may be used or developed that may be better suited for an array with a large number of wells, particularly arrays having 500 or more wells. As wells become increasingly smaller, however, conventional methods of spotting can no longer simply be scaled to accommodate smaller wells and more dense arrays, such as those in the reaction vessels described herein. Therefore, new solutions must be devised in order to facilitate spotting of reagents into the wells of such arrays.

In one approach, smaller spotting tubes can be formed by pulling a glass tube until the diameter of the distal end portion of the glass tube is less than a width dimension of the well. For example, glass capillary tubes having an outside diameter of 1.5 mm can be heated and drawn until the distal portions have a reduced outside diameter of 0.10 mm, as shown in FIG. 3B. These reduced diameters capillary tubes are sufficiently small to allow spotting of individual wells by a single capillary tube, as shown by the manual spotting in FIG. 3C.

Even if this approach described above were automated, however, the spotting of over 1,000 wells with a single drawn glass tube would still be a time-consuming endeavor, therefore, additional developments to facilitate more efficient spotting were needed. One such development included bundling a large number of capillary tubes together so that multiple wells could be spotted simultaneously. The pulled glass tubes described above can be fixed in a regular spatial arrangement and spacing that corresponds to the arrangement and spacing of wells within at least a portion of the well chamber. In some embodiments, the spacing between adjacent glass tubes correspond to wells that are adjacent. In other embodiment, the spacing between adjacent glass tubes corresponds to wells that are not adjacent, such that incremental movements of the entire bundle by a distance less than the spacing between tubes can be utilized to fill any unfilled wells. In some embodiments, the glass tubes in the bundle are secured by a framework that secures the end portions within the desired arrangement.

An example of such a bundle of capillary tubes is shown in FIG. 3D, which depicts a capillary-pack (“cap-pack”) device 300. The cap-pack device includes a bundle of glass capillary tubes 301 held in close proximity in a regular spatial arrangement so as to simultaneously spot a number of adjacent wells upon contact with the wells. Each tube includes a distal portion 302 of reduced diameter extending from the device, each having a diameter that is less than a width of the respective wells. In some embodiments, the bundle includes five or more tubes, 10 or more tubes, 20 or more tubes, 50 or more tubes, or 100 or more tubes. The tubes are fixed in a spatial arrangement so as to fill one or rows or groups of wells, for example, the tubes can be disposed in a linear arrangement so as to fill one or more rows, partly or fully, or in a rectilinear arrangement (e.g. square or rectangular array) so as to fill a correspondingly shaped block of wells. The capillary tubes are encased within a protective outer housing 304 and the cap-pack can further include a base 303 to facilitate handling and positioning of the device, either manually or preferably robotically to allow for high-throughput automation. In this manner, the wells of the microarray can be filled by sequential placement of identical cap-packs at differing portions of the array until all wells are filled. In some embodiments, the device can be part of a spotting system that includes multiple cap-packs of that are supported in an array by an automated positioning x-y-z robot, such as that shown in FIG. 3E, to allow spotting of identical reaction vessels disposed in a tray in a corresponding array, thereby allowing for high-throughput reagent spotting of multiple reaction vessels. The system can further include a heater for drying or baking the reagent vessel to facilitate drying of the liquid solution into solid form.

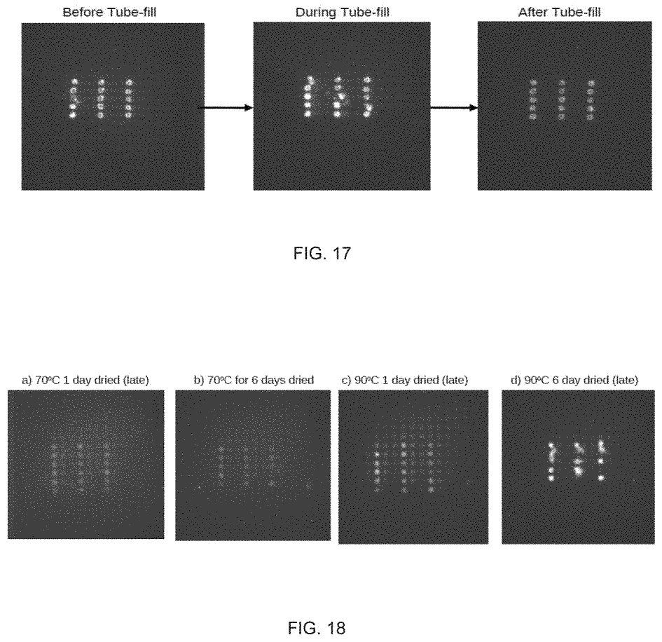

Alternatively, the spotted reagent can be removed and placed in a humidity controlled environment and allowed to dry for a set period of time (from hours to days) at an elevated temperature (typically, a temperature between 70° C. and 100° C.). The performance associated with various approaches of drying spotted reagents can be further understood by referring to the experimental results in FIGS. 17-22.

In another aspect, the glass tubes can be filled simultaneously with one or more reagents solutions (e.g. primers/probes) by inserting the distal ends in loading wells or reservoirs and relying on capillary action to withdraw the solution into the tubes. Alternatively, the device can rely on atmospheric pressure to push the fluid into the capillary tubes when submerge and the proximal ends can be capped to retain the solution within. In some embodiments, filling can include applying a negative pressure at a proximal end thereof to draw the solution into the tubes. In other embodiments, the glass tubes can be filled by injecting the one or more primers/reagents from their proximal ends.

Once loaded with the reagent solution having one or more reagents, the glass tubes are positioned at a desired location above the array (either manually or by a positioning robotics) to contact the bottom of a respective group of wells. In some embodiments, the contact pressure of the distal ends of the tubes against the bottom of the wells is enough to draw at least a small droplet of the primer or reagent from the tubes to deposit the primer or reagent at the bottom of the well. In some embodiments, a slight positive pressure may be applied at the proximal ends of the glass tubes to facilitate release of primer or reagent from the distal ends upon contact with the bottoms of the wells and to facilitate refilling of the distal tip with primer or reagent disposed more proximally within the tube. In this manner, the same bundle of tubes can be repositioned over another groups of wells for spotting with the same loaded bundle of tubes. In some embodiments, the bundle of tubes are positioned among the various groups of wells for spotting by an x-y-z positioning robotic tool.

FIG. 3F shows a workflow for high volume spotting automation with the cap-packs described above. The desired reagents are delivered into well plates (e.g. by Oligo Synthesis system), and the template specific reagent (TSR) oligos are mixed with a suitable matrix material (e.g. polymer with delayed water solubility, certain cellulose species, HEC-(Hydroxyethyl cellulose); and/or NIPAM-(n-isopropylacrylamide)) and/or Hydroxypropyl cellulose (HPC) in a liquid mixing and handling system (e.g., well-plate based) and then the cap-pack capillary tubes are filled with the reagent solution.

In yet another approach, an automated spotting system, such as those manufactured by BioDot, can be used to spot the wells. In some embodiments, these spotting system utilize non-contact piezoelectric dispenser, and can dispense 100-1000 pL, CV<10%. These system can spot multiple reaction vessels at one a time, nested within the tray, as shown in FIG. 3F. In this example, 30 reaction vessels can be spotted by the automated robotic spotter. These spotting machines utilized droplet optimization cameras and vision system to ensure accurate spotting. Such systems are compatible with conventional well plates (e.g. 96 well plate by Dr. Oligo). However, these spotting system are still generally considered low volume spotting and cannot merely be scaled up to accommodate the high density wells of the reaction vessels described herein. Thus, the workflow of such systems must be modified to provide high volume spotting automation.

II. Sample Loading into Reaction Vessels

An overview of an exemplary filling of fluid sample within the reaction vessel is as follows: 1) wells are pre-spotted with TSR reagents; 2) the pre-amplification chamber is filled with a light oil (e.g. silicone oil) that can float atop the sample fluid to trap moisture following by the pre-amplification fluid sample, 3) the pre-amplified sample is removed and withdrawn back into the cartridge and picks up the final amplification reagent bead (e.g. EZR2 bead), 4) well chamber and wells are filled with amplified fluid sample mixed with the reagent bead, and 5) well chamber is filled with oil to remove excess fluid sample and cap the wells. In some embodiments, the well chamber is filled with a heavier oil (e.g. GPL) to squeegee off any excess fluid sample from the wells and followed by a lighter oil (e.g. mineral oil) for capping wells. Additional details in regard to filling of the wells can be understood further by referring to the examples below.

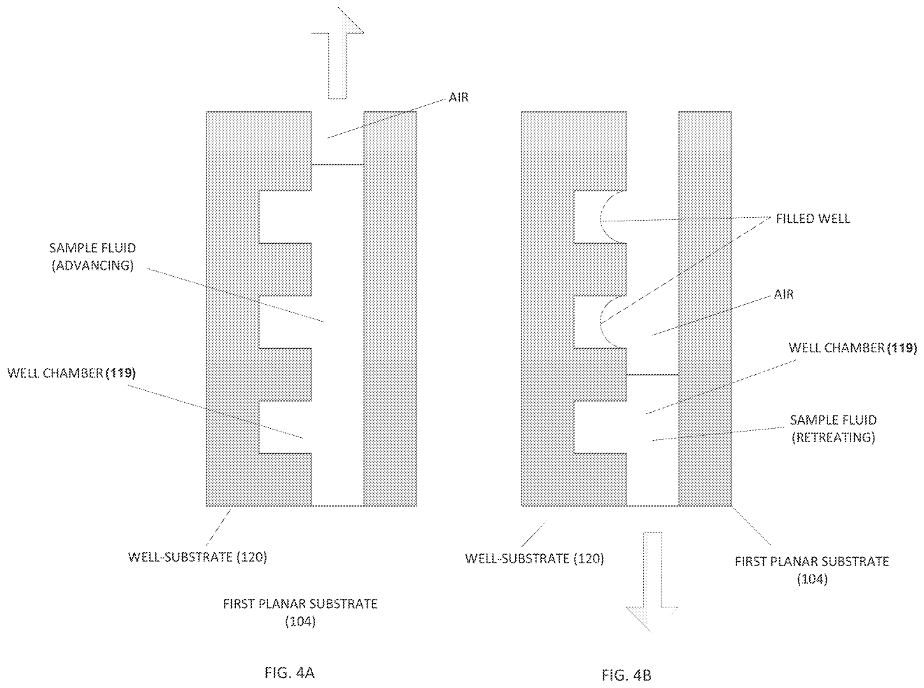

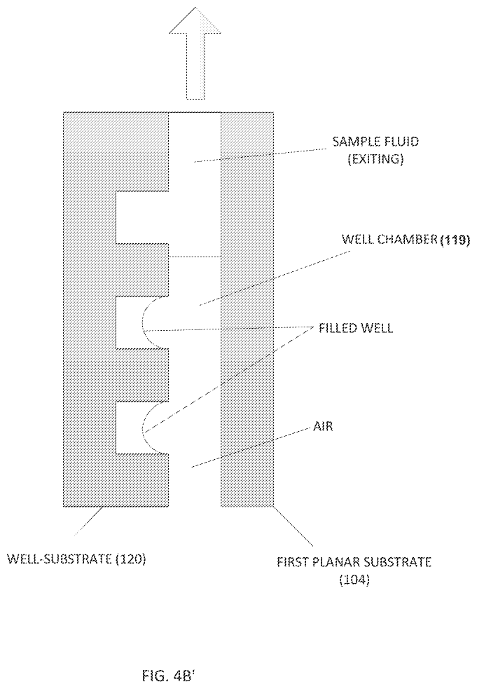

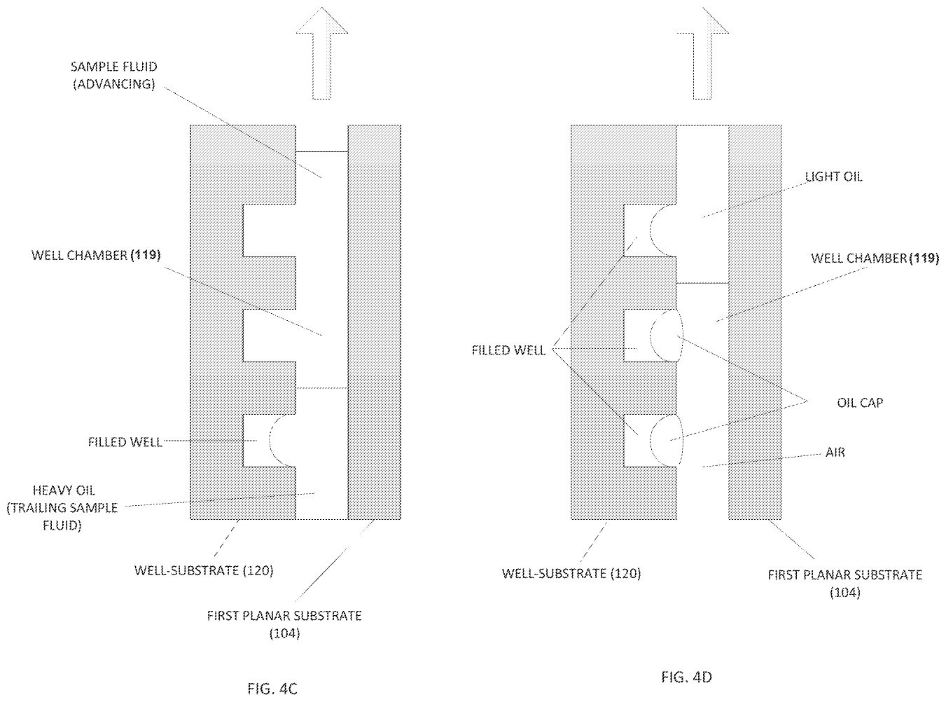

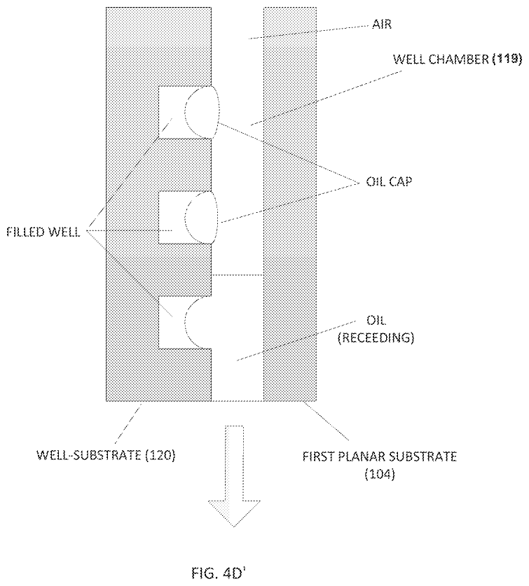

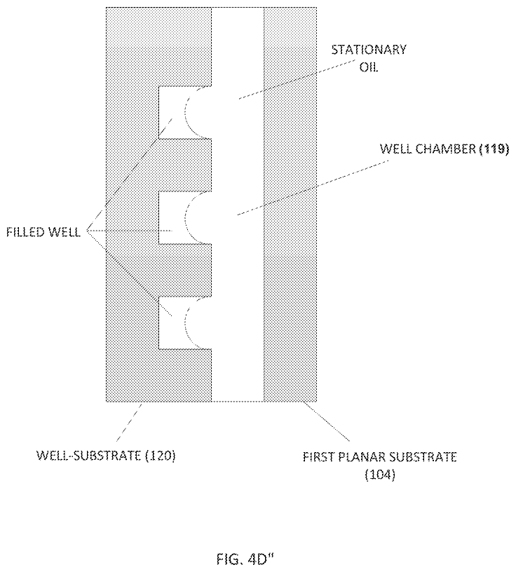

FIGS. 4A and 4B show a method of filling the well-substrate 120 with a sample fluid. In FIG. 4A a sample fluid is advanced (e.g., via pressure) between the well-substrate 120 and the first planar substrate 104. As the fluid passes over the well-substrate 120, each well becomes filled with fluid, which is primarily retained within the wells via surface tension. As recited above, portions of the well-substrate 120, such as the walls defining the wells, can be coated with a hydrophilic substance or treated to become relatively more hydrophilic, and thus encourage complete and uniform filling of the wells as the sample fluid passes over. In some embodiments, other surfaces of the well-substrate 120, such as top surfaces surrounding the well surfaces, can be coated with a hydrophobic substance or treated to become relatively more hydrophobic, such that the fluid sample is only retained in the wells and not on adjacent surfaces, which can cause inconsistent testing results. In some embodiments, the interior surface of the first planar substrate 120, can be coated or treated for a hydrophobic effect. In FIG. 4B, it can be seen that only the wells are filled after the sample fluid is retreated. In some embodiments, a fluid sample can be advanced as shown in FIG. 4B′, followed by a pocket of air, thus eliminating the need to withdraw the sample as illustrated in the exemplary embodiment shown in FIG. 4B. Filling methods such as “discontinuous wetting” can also be used as disclosed by Jackman et al., Anal Chem., 1998, 70, 2280-2287 and by Hatch et al., MULTILAYER HIGH-DENSITY 3D NANOWELL ARRAYS FOR DIGITAL BIOLOGY, 15th Int'l. Conference on Miniaturized Systems for Chemistry and Life Sciences, Oct. 2-6, 2011, 269-271. Generally, the well-substrate 120 should be de-wetted as quickly as possible to avoid cross-contamination of different primers within the wells.

FIGS. 4C and 4D show another method of filling the well-substrate 120 with a sample fluid. In FIG. 4C, the well-substrate 120 is filled according to a combination of the techniques shown in FIGS. 4A and 4B. However, the sample fluid is trailed by a pocket of oil. In some embodiments, this oil is a heavier oil, such as a GPL oil or fluorinated oil (e.g., a perfluoropolyether (PFPE) also called perfluoroalkylether (PFAE) or perfluoropolyalkylether (PFPAE), GPL 103), which acts to squeegee off the excess fluid sample from the surface of the well-substrate and force excess fluid out of the well chamber; Although the oil in FIG. 4C is shown directly contacting the sample fluid, an air gap can be provided between the oil cap and the sample fluid if the well chamber was previously evacuated of the fluid sample.

As shown in FIG. 4D, after each well is filled with sample fluid, and excess fluid sample is removed from the well chamber by the heavy oil, another lighter oil, such as mineral oil, can be introduced and fill the well chamber in order to “cap” off each well with the lighter oil, which can aid in reducing evaporation when the well-substrate 120 is subjected to heat cycling. The lighter oil can be introduced directly after the heavier oil, as shown. In some embodiments, the lighter oil can be introduced after evacuation of the heavier oil. The heavier oil can be evacuated from either port. In some embodiments, the oil trap is configured to stop oil migration or seeping of the oil from the pre-amplification chamber into the well chamber. In some embodiments, after the wells have been filled, oil can be introduced from the top of the chamber and withdrawn from the chamber entrance 124 as shown in FIG. 4D′. In both of the embodiments shown in FIG. 4D and FIG. 4D′, after the wells have been capped with oil, an aqueous solution can fill the chamber 118 to improve thermal conductivity. In some embodiments, the stationary aqueous solution can be pressurized within the chamber 118 to halt the movement of fluid and any bubbles. Alternatively, the well chamber above the wells can remain empty with an air gap.

In other embodiments, after the wells have been filled, oil can be held stationary within the chamber during heat cycling, as shown in FIG. 4D″. In some embodiments, the stationary oil can be pressurized within the chamber 118 to halt the movement of fluid and any bubbles.

Oil such as mineral oil can be used for isolation of each well and to provide thermal conductivity. However, embodiments of the invention are not limited to “oil”. Any thermal conductive liquid, such as fluorinated liquids (e.g., 3M FC-40) can be used. Hence, references to “oil” in this disclosure should be understood to include such alternatives.

In some embodiments, after the wells have been filled with sample fluid as shown in FIG. 4C, oil can follow the sample fluid to remove excess fluid oil and the same oil or a different oil can be used to cap the wells. An experiment detailing this embodiment was performed as described in Example 3 and as shown in FIG. 4E.

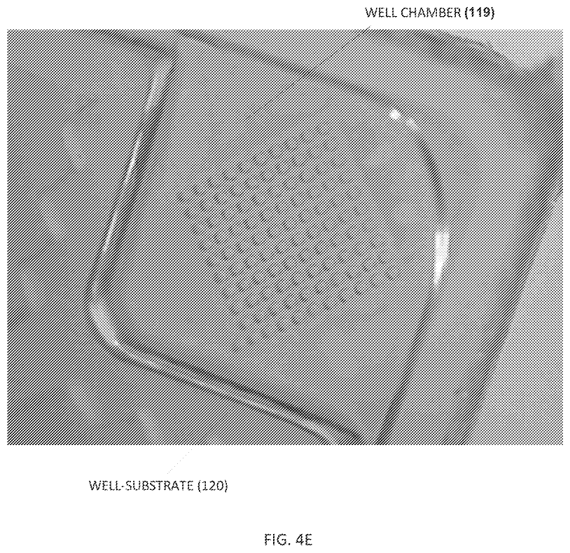

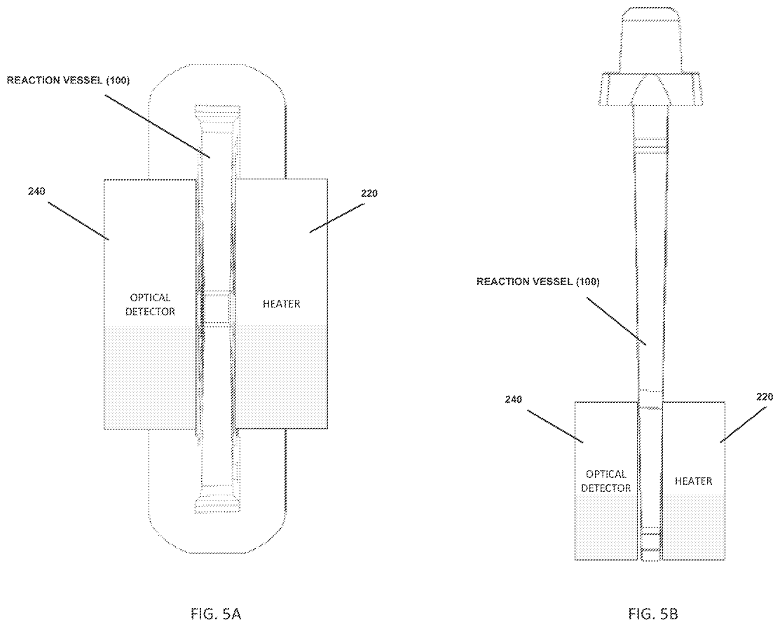

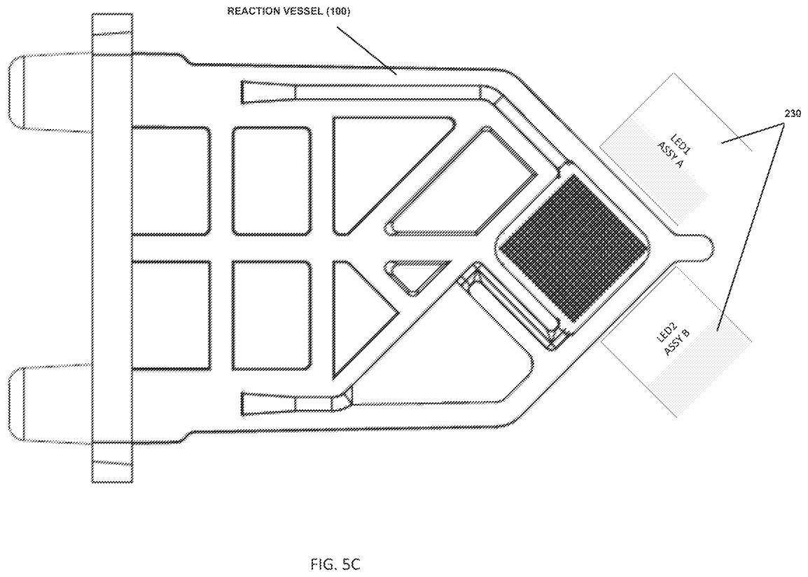

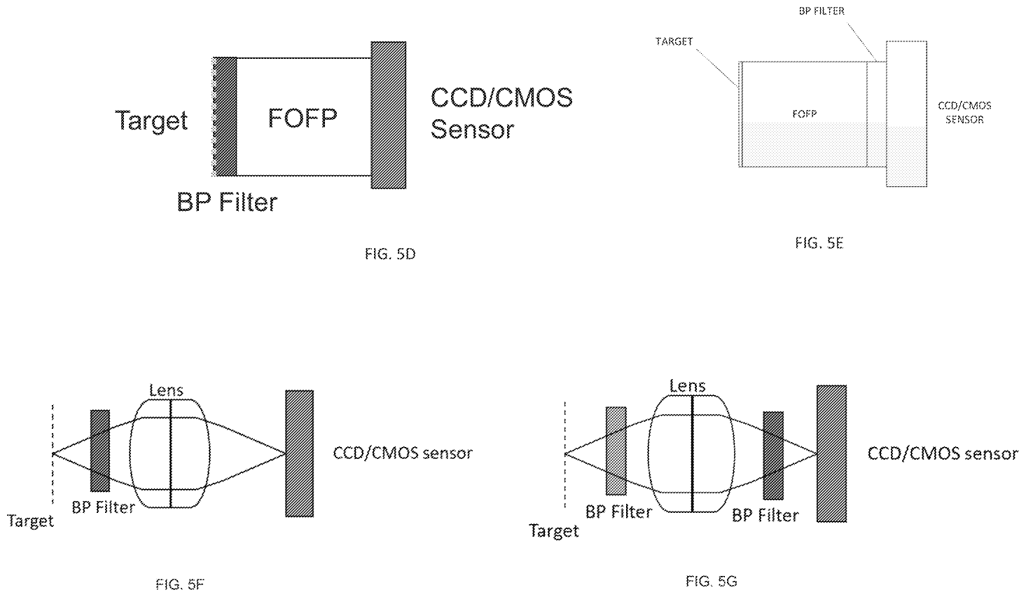

FIGS. 5A and 5B show an exemplary sensor assembly positioning for detecting reactions at the well-substrate 120. In this embodiment, heater 224 is positioned directly adjacent or against the second planar substrate 106 so as to effect thermal cycling of the fluid sample within the pre-amplification chamber. Optical detector 240 is positioned directly adjacent or against the transparent first planar substrate 104 so as to facilitate optical detection of reactions occurring within any of the wells. Optical excitation can be performed through the sides of the frame by optical excitation means, such as those shown in FIG. 5C.

FIG. 5C shows an exemplary sensor assembly configuration that can be used in combination with the configuration of FIGS. 5A and 5B. Here, the optical excitation means 230 includes a LED assembly A is positioned along the upper forward edge of the reaction vessel 100 and a second LED assembly B is positioned along the lower forward edge of the reaction vessel 100. By utilizing two different LED assemblies that emit in differing wavelengths (e.g. red and green), the system can provide for excitation and detection of differing target analytes within the same reaction vessel. It is appreciated that the system can utilize only a single excitation means that emits in a single wavelength range, or a single excitation means that is capable of emitting sequentially in differing wavelength ranges in rapid succession.

FIG. 5D shows an exemplary sensor assembly configuration. In some embodiments, this sensor assembly configuration can be used in conjunction with the configuration shown in FIGS. 5A-5C. The sensor assembly includes a CCD/CMOS detector coupled to a fiber optic face plate (FOFP). A filter is layered on top of the FOFP, and placed against or adjacent to the target, which here is the well-substrate 120. Alternatively, the filter can be layered (bonded) directly on top of the CCD with the FOFP placed on top as shown in FIG. 5E.

FIGS. 5F-5G shows another exemplary sensor assembly configuration. In some embodiments, this configuration can be used in conjunction with one or more of the configurations shown in FIGS. 5A-5D. Here, a CCD/CMOS detector coupled to a double lens configuration with a filter placed in between. In some embodiments, the filter can be bonded to the CCD/CMOS detector. In some embodiments, a filter may be placed between the target and a single lens assembly which is used to focus the image onto the detector (see FIG. 5F). In some embodiments, a filter may be placed between the target and a single lens assembly and between the lens assembly and the detector (see FIG. 5G).

III. Methods for Use

In some embodiments, a sample fluid is first introduced into the second fluidic port 112 and through pre-amp inlet passage 113 and into the pre-amplification chamber 116, which is filled with the sample fluid. In some embodiments, the fluid sample within the pre-amplification chamber can be thermally cycled by an external heater adjacent the second substrate until the fluid sample is sufficiently amplified. In some embodiments, the pre-amplification chamber 116 can include one or more chemicals to cause a desired chemical reaction, and thereby further amplify the fluid therein. In some embodiments, the fluid can be maintained within the pre-amplification chamber 116, up to, but not past, the pre-amplification chamber exit at the top of the pre-amplification chamber, until the desired reaction occurs. Preferably, the pre-amplification chamber is sized so as to contain the entire fluid sample when amplified. In one aspect, a light oil is introduced into the pre-amplification chamber before introduction of the fluid sample. This light oil remains atop the fluid sample during amplification, which helps maintain the fluid sample within the pre-amplification chamber and prevents moisture from the fluid sample from traveling along the fluidic path downstream of the pre-amplification chamber. The light oil can be stored within a chamber of the sample cartridge. The serpentine passage that extends beyond the exit of the pre-amplification chamber prevents moisture and/or excess fluid (e.g., oil or fluid sample) from the fluid sample being amplified from traveling through the fluidic path and into the well chamber, where any moisture or fluid would foul the empty wells. Any moisture or fluid that does travel into the serpentine channel winds through the serpentine channel. If any moisture or fluid does travel entirely through the fluid channel it encounters the fluidic path valve, which constricts further flow causing the fluid to accumulate and inhibits flow into the well chamber. If excess fluid does continue further beyond the fluidic path valve, then the fluid travels through the oil trap valve and accumulates in the oil trap chamber. In this manner, any excess fluid or moisture is prevented from flowing into the well chamber during pre-amplification.

Once the fluid sample is amplified, the amplified fluid sample is evacuated through the same pre-amp passage 113 and back into the sample cartridge by reversing the fluid flow direction. The amplified fluid sample is then introduced from the sample cartridge and introduced back into the reaction vessel through the first fluidic port 110 and into the inlet passage 128 and then passes the well chamber entrance 124 and into the well chamber 119. The wells of the well-substrate 120 can then be filled, for example, according to methods shown in FIGS. 4A-4D″. Once the wells of the well-substrate 120 are filled, the excess amplified fluid sample can be evacuated from the well chamber 119, either through the well chamber exit at top and through the intermediate-passage and serpentine passage into the pre-amplification chamber or back through the well chamber entrance and inlet passage 128 and back into the sample cartridge. In some embodiments, an oil, such as mineral oil, can then be introduced into the well chamber and coated over the filled wells to isolate the wells and prevent evaporation during thermal cycling. Excess oil can be advanced further along the fluidic sample by introducing air into the well chamber through the well chamber entrance or by evacuating excess oil through the well chamber entrance and back into the sample cartridge.

Introduction of fluid sample, oils or air into the reaction vessel through either of the fluidic ports is facilitated by applying pressure via the fluidic interface. In some embodiments, pressure ranging from 5 to 20 psi will applied to the well-chamber 119. Thus, PCR buffer as well as any thermally conductive liquid (oil) are under compression to hold PCR liquid and any small bubbles—possibly generated during rehydration of the dried primers. This application of pressure can cause immobilization of any generated bubbles, so that no optical interference from moving bubbles and liquid occurs. In other embodiments, a hydration fluid, such as distilled water, can be heated within the pre-amplification chamber 116, or one of the auxiliary chambers 132, such that the well chamber 119 has 100% humidity, or sufficient enough humidity to prevent over evaporation during thermal cycling. After filling is complete, the well-substrate 120 can be heated by an external device that is in thermal contact with the reaction vessel 100 to perform thermal cycling for PCR. In some embodiments, non-contact methods of heating can be employed, such as RFID, Curie point, inductive, or microwave heating. These and other non-contact methods of heating are well known to persons of ordinary skill in the art and can be readily applied to the reaction vessel as disclosed herein. During thermal cycling, the reaction vessel can be monitored for reactions via the sensor arrangements described in FIGS. 5A-5G.

A variety of biological assays can be performed using the reaction vessel 100, typically for the purpose of indicating the presence of at least one analyte of interest in a test sample. These assays include, but are not limited to, binding assays based on specific binding affinity between a pre-selected pair of molecules (such as an antibody-antigen binding pair or two polynucleotide sequences with sufficient complementarity), nucleic acid amplification reactions relying on certain pre-determined nucleotide sequence-based criteria, and chemical reactions indicative of the presence of molecules of pre-defined activity (such as enzymes).

In some embodiments, analytic agents or probes that are deposited in the reaction vessel in a pre-determined arrangement, for example, “bait” proteins or nucleic acids, are directly immobilized on the surface of a solid substrate with minimal structural alternation or modification of the substrate surface. In other words, the agents or probes are essentially “spotted” on the surface and arranged and confined within a 2-dimensional space. In some embodiments, the substrate can be manufactured to form an arrangement of multiple wells or indentations of pre-determined dimensions to house the agents or probes, which can be permanently immobilized within the wells or indentations, or temporarily confined within the wells or indentations for the assay time duration. In other words, the analytic probes will be confined within a 3-dimensional space.

Material suitable to serve as analytic probes of the reaction vessel includes selection of proteins (e.g., full length proteins such as antibodies, protein fragments, or short peptides), nucleic acids (e.g., DNA, RNA, microRNA), carbohydrates, lipids, tissues, cells, or molecules of virtually any and all chemical nature. In other words, any material/molecule that is known to be used to make microarrays for multiplexing assays can be used in the reaction vessels of this invention.

IV. Detection of an Analyte of Interest

One aspect of the present invention relates to the monitoring of an optical signal (using the sensor configurations of FIGS. 5A-5G) indicative of the presence in a test sample of at least one analyte of interest, for example, a target protein (e.g., an antibody of a particular antigenicity), a target cell, a target gene, a target sequence of genes, a target mRNA transcription, or a target nucleic acid. Such target analyte(s) can be of any origin: viral, bacterial, fungal, parasitic (e.g., from a protozoan), animal, or human origin. For example, viral proteins, antibodies against viral antigens, or DNA/RNA sequences derived from a bacterial, or viral genome can be the analytes of interest for detection in test samples. Exemplary non-limiting target analytes can include a nucleic acid sequence such as a micro RNA, mammalian genes, genetic variants of a mammalian gene, such as various genetic mutants, allelic variants, or epigenetic variations (exhibiting different profiles in methylation status) within oncogenes, tumor suppressor genes, or any other genes that have been implicated as relevant to certain diseases and conditions, can be the focus of detection in the application of the reaction vessels of this invention. Exemplary viruses the genes and/or proteins of which can be targets of interest can include but are not limited to human immunodeficiency virus-1 (HIV-1), human cytomegalovirus (CMV), hepatitis C virus (HCV), Hepatitis B virus (HBV), Human Papiloma Virus (HPV), enterovirus, varicella-zoster virus; flaviviruses, hepadnaviruses, herpesviruses, noroviruses, orthomyxoviruses, parvoviruses, papovaviruses, paramyxoviruses, pestiviruses, picornaviruses, and influenza. Exemplary bacteria the genes and/or proteins of which can be targets of detection can include, but are not limited to, Mycobacterium tuberculosis (TB), Bacillus anthracis, legionella pneumophilia, Listeria monocytogenes, Neisseria gonorrhoeae, Chlamydia trachomatis, Neisseria meningitides, xtaphylococcus aureus, Helicobacter pylori, and Enterococcus faecalis. Exemplary human genes of potential interest can include, but are not limited to, p53, BRCA1 and BRCA2, Her2/Neu and other EGFR family members, BCR-ABL, PTEN, RAS, RAF, Src, RB, Myc, VEGF, topoisomerase, and the APOEc4 allele.

Basic techniques of detecting and/or quantifying various analytes of interest can be found in, for example, Sambrook and Russell, Molecular Cloning, A Laboratory Manual (3rd ed. 2001); Kriegler, Gene Transfer and Expression: A Laboratory Manual (1990); Ausubel et al., Current Protocols in Molecular Biology (1994); and Harlow & Lane, Antibodies, A Laboratory Manual (1988).

For the purpose of detecting the presence of a protein of any particular identity, one can employ a variety of binding affinity-based assays, such as immunological assays. In some embodiments, a sandwich assay format can be performed by capturing a target protein from a test sample with an antibody (which is immobilized to a pre-determined spot in a well array format or confined within a pre-determined wells of the reaction vessel) having specific binding affinity for the polypeptide. The presence of the protein can then be indicated with a secondary antibody attached to a detectable label, such as a fluorescence-generating molecule.

For the purpose of detecting the presence of a nucleic acid of interest, a probe, or a molecule containing a polynucleotide sequence substantially complementary to the target nucleic acid sequence and capable of hybridizing to the target sequence based on the Watson-Crick base-pairing, is typically used. Again, the probe can be immobilized or spotted to the surface of a solid substrate at a pre-determined location, or in some embodiments, the probe can be confined to a well at a pre-determined location within a predetermined pattern on the substrate. Depending on the nature of the target polynucleotide being detected, for example, whether it is double-stranded or single-stranded, a detection probe can be substantially identical in sequence to the target sequence or substantially identical in sequence to the complementary sequence of the target sequence. In other words, the probe is capable of specially bind to the target nucleotide sequence. In some cases, the probe can contain one binding segment to the target nucleotide as well as a non-binding segment, so long as the presence of the non-binding segment does not interfere with the specific binding between the binding segment and the target nucleic acid. Typically, the binding segment will have at least 8, often at least 10, 12, 15, 20, 25, 30 or even more, contiguous nucleotides that are complementary to either strand of the target polynucleotide sequence, in order to ensure specific recognition of the target sequence. A probe can, in some embodiments, include a light-emitting moiety for easy detection, e.g., a fluorescent or luminescent molecule such as fluorescein, rhodamine, Texas Red, phycoerythrin, hydroxycoumarin, aminocoumarin, Cascade Blue, Pacific Orange, Lucifer Yellow, allophycocyanin, TruRed, FluorX, or a lanthanide.

In some embodiments, different fluorescent indicators are employed for indicating the presence of distinct polynucleotide sequences. In some embodiments, a melting point-based detection method can be effective for detecting the presence of distinct target polynucleotide sequences when a common fluorescent indicator is used.

Aside from the binding assay format where detection of an analyte of interest is made directly based on binding affinity of the analyte to the analytic agent provided in the reaction vessel, an amplification-based assay system for detection and/or quantitation of nucleic acids of interest offers a broad spectrum of applications. In this amplification-based system, one or more nucleic acids of interest is detected and/or quantified upon completion of a sequence-specific amplification reaction. Furthermore, for the purpose of detecting a target nucleic acid by an amplification-based method, multiple sets of primers can be included in each well to permit detection carried out in the nested PCR format, for example, the first set of primers can define a portion of the target sequence and generate an amplicon that allows further amplification by one or more subsequent set of primers.

As used herein, the term array, microarray and nano array describes a plurality of wells that are set into the surface of a solid substrate at pre-designated locations. In some embodiments, a reaction vessel contains at least about 100 or about 200 wells. In some embodiments, the reaction vessel can contain any number of wells between about 100 and about 300, about 400, about 500, about 600, about 700, about 800, about 900, about 1000, about 1100, about 1200, about 1300, about 1400, about 1500 or more wells. The wells can be of any shape and their locations although predetermined can be arranged in any format or pattern on the substrate. As used herein the term “reaction vessel” can be used interchangeable with “multi-well reaction chamber” or “multi-well reaction tube”.

In some embodiments, the nucleic acid of interest is a DNA molecule. Sequence-specific amplification is performed by providing at least one set of primers, free nucleotides, and appropriate DNA or RNA polymerase in each well of the reaction vessel format, and then subjecting the reaction vessel to appropriate temperatures and time durations to achieve the synthesis and amplification of any target polynucleotide sequence.

Each primer is typically an oligonucleotide (which can be either natural or synthetic) capable, upon forming a duplex with a polynucleotide template by base-pairing, of acting as a point of initiation of nucleic acid synthesis and being extended from its 3′ end along the template so that an extended duplex is formed. Extension of a primer is usually carried out with a nucleic acid polymerase, such as a DNA or RNA polymerase. The sequence of nucleotides added in the extension process is determined by the sequence of the template polynucleotide. In most embodiments, primers are extended by a DNA polymerase. Frequently, primers have a length in the range of from about 14 to about 40 nucleotides, or from about 15 to about 20 nucleotides. Primers are employed in a variety of nucleic acid amplification reactions, for example, linear amplification reactions using a single primer, or polymerase chain reactions (PCR), employing two or more primers. Guidance for selecting the lengths and sequences of primers for particular applications is well known to those of ordinary skill in the art, see, e.g., Dieffenbach, editor, PCR Primer: A Laboratory Manual, 2^{nd} Edition (Cold Spring Harbor Press, New York, 2003).

In the context of a nucleic acid amplification reaction such as a PCR, the amplification product of a target polynucleotide sequence is referred as an “amplicon.” Amplicons are a population of polynucleotides resulted from primer extension, usually in the form of double stranded polynucleotides. Amplicons can be produced by a variety of amplification reactions whose products are replicates after multiple rounds of amplification of one or more target nucleic acids. Generally, amplification reactions producing amplicons are template-driven in the base pairing of reactants: both nucleotides and oligonucleotide primers have complements in a template polynucleotide or target polynucleotide sequence. Such complementarity is required for the production of reaction products, or amplicons. In some cases, template-driven reactions are primer extensions with a nucleic acid polymerase or oligonucleotide ligations with a nucleic acid ligase. Such reactions include, but are not limited to, polymerase chain reaction (PCR), linear polymerase reaction, ligase chain reaction (LCR), strand-displacement reaction (SDA), nucleic acid sequence-based amplification (NASBA), rolling circle amplifications, and the like, see, e.g., Mullis et al., U.S. Pat. Nos. 4,683,195; 4,965,188; 4,683,202; and U.S. Pat. No. 4,800,159 (PCR); Gelfand et al., U.S. Pat. No. 5,210,015 (real-time PCR using TaqMan probes); Wittwer et al., U.S. Pat. No. 6,174,670; Landegren et al., U.S. Pat. No. 4,988,617 (LCR); Birkenmeyer et al., U.S. Pat. No. 5,427,930 (gap-LCR); Kacian et al., U.S. Pat. No. 5,399,491 (NASBA); Walker, U.S. Pat. Nos. 5,648,211 and 5,712,124 (SDA); Lizardi, U.S. Pat. No. 5,854,033; Aono et al., Japanese Patent Application Publication No. JP 4-262799 (rolling circle amplification); and the like. In some embodiments, amplicons of one or more target nucleic acids are produced by one or more rounds of PCR, e.g., nested PCR, performed in the reaction vessel of the present invention.

A polymerase chain reaction, or PCR, is an enzyme-mediated reaction for the in vitro amplification of specific DNA sequences by the simultaneous, multiple rounds of primer extensions of complementary strands of DNA. In other words, a PCR is a reaction for making multiple copies or replicates of a target nucleic acid flanked by primer binding sites, such reaction comprising one or more repetitions of the following steps: (i) denaturing the target nucleic acid; (ii) annealing primers to the primer binding sites; and (iii) extending the primers by a nucleic acid polymerase in the presence of nucleoside triphosphates. The reaction is typically cycled through different temperatures optimized for each of the denaturing, annealing, and extension steps. Particular temperatures, time durations at each step, and rates of change between steps depend on many factors well-known to those of ordinary skill in the art, see, e.g., McPherson et al., editors, PCR: A Practical Approach and PCR2: A Practical Approach (IRL Press, Oxford, 1991 and 1995, respectively). For example, in a conventional PCR using Taq DNA polymerase, a double stranded target nucleic acid can be denatured at a temperature >90° C., primers annealed at a temperature in the range 50-75° C., and primers extended at a temperature in the range 72-78° C.

The term “PCR” encompasses derivative forms of the reaction, including but not limited to, reverse transcription (RT)-PCR, real-time PCR, nested PCR, quantitative PCR, multiplexed PCR, and other similar variations. For these various PCR assays, typical reaction volumes can range from nanoliters, e.g., about 0.1- to about 500 nL, to microlitters, e.g., about 1-about 5 μL, and can be readily contained within the wells of the reaction vessels the present invention, thus allowing a rapid multiplexing analysis. In some non-limiting exemplary embodiments, the reaction volume within each of the wells of the reaction vessel are about 0.1, 0.2, 0.3, 0.4, 0.5, 0.6. 0.7, 0.8, 0.9. 1, 1.5, 2, 2.5, 3, 3.5, 4, 4.5, 5, 5.5, 6, 6.5, 7, 7.5, 8, 8.5, 9, 9.5, 10, 12, 14, 16, 18, 20, 25, 30, 35, 40, 45, 50, 55, 60, 65, 70, 75, 80, 85, 90, 95, and 100 nL.

A reverse transcription PCR or RT-PCR is a particularly powerful tool for the detection and analysis of RNA in a sample. An RT-PCR is a PCR preceded by a reverse transcription reaction when a target RNA is converted to a complementary single stranded DNA, which is then amplified in the regular PCR process, see, e.g., Tecott et al., U.S. Pat. No. 5,168,038.

A real-time PCR is a PCR process during which the amount of reaction products, i.e., amplicons, is monitored at the same time while the reaction proceeds. There are many forms of real-time PCR that differ mainly in the means of detection used for monitoring the reaction product(s), see, e.g., Gelfand et al., U.S. Pat. No. 5,210,015 (TaqMan probes); Wittwer et al., U.S. Pat. Nos. 6,174,670 and 6,569,627 (intercalating dyes); Tyagi et al., U.S. Pat. No. 5,925,517 (molecular beacons). Detection chemistries for real-time PCR are reviewed in Mackay et al., Nucleic Acids Research, 30: 1292-1305 (2002).

A nested PCR is a PCR process that involves at least two stages of amplification where the amplicon of a first stage PCR using a first set of primers becomes the template for a second stage PCR using a second set of primers. At least one primer of the second set of primers has sequence complementarity and can hybridize to the target polynucleotide sequence at a location that is between the hybridization sites of the two primers of the first set, i.e., at a location within the sequence of the amplicon of the first stage PCR.

A multiplexed PCR is a PCR process where amplification of multiple potential target polynucleotide sequences are simultaneously carried out in the same reaction mixture, see, e.g., Bernard et al., Anal. Biochem., 273: 221-228 (1999) (two-color real-time PCR). The reaction vessel assay format of the present invention is suitable for carrying out multiplexed PCR. A distinct set of primers is contained in a well-intended for the amplification and detection of a distinct target polynucleotide sequence. Typically, there are a number of repeat wells containing the same primers as duplicate wells in the well array arrangement. For example, in a non-limiting exemplary embodiment, one entire well array can include different pre-made reaction mixtures each containing a distinct primer set selected from a total of up to 8, 16, 25, 50 or even 100 different sets of primers, with a cluster of 8 replicate wells provided for each reaction mixture containing a distinct set of primers.

A quantitative PCR is a PCR process that allows one to measure the abundance of one or more specific target sequences in a sample. Quantitative PCRs can involve measuring both absolute quantitation and relative quantitation of the target sequences. Quantitative measurements are made using one or more reference sequences that can be assayed separately or together with a target sequence. The reference sequence can be endogenous (naturally existing) or exogenous (artificially added) to a sample, and in the latter case, can comprise one or more competitor templates. Typical endogenous reference sequences include segments of transcripts of the following genes: β-actin, GAPDH, β₂-microglobulin, ribosomal RNA, and the like. Techniques for quantitative PCR are well-known to those of ordinary skill in the art, see, e.g., Freeman et al., Biotechniques, 26: 112-126 (1999); Becker-Andre et al., Nucleic Acids Research, 17: 9437-9447 (1989); Zimmerman et al., Biotechniques, 21: 268-279 (1996); Diviacco et al., Gene, 122: 3013-3020 (1992); Becker-Andre et al., Nucleic Acids Research, 17: 9437-9446(1989).

An amplification reaction can be a “real-time” amplification if a detection mechanism is available that permits a reaction product to be measured at the same time as the amplification reaction progresses, e.g., real-time PCR described above, or real-time NASBA as described in, e.g., Leone et al., Nucleic Acids Research, 26: 2150-2155 (1998). As used herein, the term “amplifying” means performing an amplification reaction. A “reaction mixture” is a solution (or a lyophilized version of such solution) containing all the necessary reactants for performing a reaction, which can include, but are not be limited to, buffering agents, salts, co-factors, scavengers, and the like. In some embodiments, a lyophilized reagent is deposited in a well of the reaction vessel during manufacturing process. In some embodiments, the lyophilized reagent contains at least one set of primers for amplification of one or more target polynucleotide sequences, nucleoside triphosphates, enzyme(s), and/or a detection moiety that indicates the presence and/or quantity of one or more amplicons. In some embodiments, the detection moiety is a fluorescent indicator. Detection or quantification of amplicons in a real-time PCR often involves the use of a fluorescence resonance energy transfer probe, or a FRET probe, such as a TaqMan® probe, a Molecular beacon probe, or a Scorpion probe.

As used herein, a fluorescent indicator is a molecule (e.g., a dye, or a probe) that is capable of generating a fluorescent signal in the presence of a product or products of an amplification reaction (i.e., an amplicon) such that as the amplicon accumulates in the reaction mixture the signal of the fluorescent indicator increases, at least over a predetermined range of amplicon concentrations.

Several types of fluorescent indicators can be used in the amplification reactions performed in the reaction vessels of this invention: first, a fluorescent dye can be used. Suitable dyes of this class are non-specific with regard to the polynucleotide sequence of the amplicon, such as intercalating dyes that bind to double-stranded DNA products, for example, ethidium bromide, SYBR Green I and II, SYBR Gold, YO (Oxazole Yellow), TO (Thiazole Orange), and PG (PicoGreen), see, e.g., Ishiguro et al., Anal. Biochem., 229: 207-213 (1995); Tseng et al., Anal. Biochem., 245: 207-212 (1997); Morrison et al., Biotechniques, 24: 954-962 (1998). Additional fluorescent indicators suitable for use with the invention are well known to persons of ordinary skill in the art.

Second, in some cases one or more primers can be designed to having a hairpin structure with a fluorescent molecule held in proximity to a fluorescent quencher, such that the fluorescence is quenched by the quencher until the hairpin structure is forced apart by primer extension, see, e.g., Whitecombe et al., Nature Biotechnology, 17: 804-807 (1999) (Amplifluor™ primers). Suitable fluorescent molecules include those mentioned in an earlier section.

Third, fluorescent indicators also can be specific for the polynucleotide sequence of a target nucleic acid. Often referred to as fluorescent probes, this type of indicators usually comprise a fluorescent moiety in proximity to a fluorescent quencher until an oligonucleotide moiety to which they are attached specifically binds to an amplification product, see, e.g., Gelfand et al., U.S. Pat. No. 5,210,015 (TaqMan probes); Nazarenko et al., Nucleic Acids Research, 25: 2516-2521 (1997) (scorpion probes); Tyagi et al., Nature Biotechnology, 16: 49-53 (1998) (molecular beacons). Fluorescent indicators can be used in connection with real-time PCR, or they can be used to measure the total amount of reaction product at the completion of a reaction. For a review of various molecular beacons and other hairpin probes, see Broude, Encyclopedia of Diagnostic Genomics and Proeomics, 2005, pages 846-851.

Typically, for each reaction performed in the reaction vessels of this invention, regardless of its nature of being binding affinity-based or amplification-based, there will be at least one positive control and one negative control, such that these controls will yield confirmation of a successful reaction: any positive signal detected is not due to a system-wide contamination, and any negative signal detected is not due to the failure of the assay system. In some embodiments, an internal standard can be included. An internal standard is a known molecule that participates in the same reaction, for example, a nucleic acid sequence that is amplified in the same amplification reaction as a target polynucleotide, in order to allow quantification (either relative quantification or absolute quantification) of the target analyte in a sample. An internal standard can be endogenous, i.e., known to be pre-existing in a sample, or exogenous, i.e., added prior to testing.

V. Designing Analytic Agents to Accommodate Reaction Conditions

Because the multiplexing assays to be performed in the reaction vessels of this invention are typically carried out under the approximately same conditions at approximately the same time, the analytic agents located on each spot or within each well of the reaction vessel must be carefully designed in order to achieve optimal or near optimal reaction results under a set of pre-determined reaction parameters. In one example, 8 different polynucleotide probes are spotted or immobilized on the substrate surface for detecting 8 distinct target nucleic acids in a sample by virtue of sequence complementarity-based hybridization. It is well within one of ordinary skilled in the art to design and optimize each target probe sequence to fall within the pre-determined reaction parameters for a particular assay. In designing and optimizing a probe, non-limiting parameters include probe length, relative location within the target sequence, and GC content that will result specific hybridization between the probe and its target under the given reaction conditions for a particular assay.

In another example, 8 sets of different reaction mixtures intended for amplification of 8 different target polynucleotide sequences are arranged in a 4-patch format, each patch containing 8 replicate wells of each reaction mixture. Each of these 8 sets of different reaction mixtures contains at least one set of oligonucleotide primers for amplification of a distinct target sequence. These 8 sets of primers can be designed such that the denaturing, annealing, and extension steps can all be completed adequately for 8 different target sequences under the same temperatures and during the same time frame.

A skilled artisan will be able to accomplish the necessary design by adjusting the length, GC-contents of the probes or primers. In some cases, substituting naturally occurring nucleotides with modified or artificial nucleotides is effective to further fine-tune the annealing/denaturing behavior of the probe and primers. See, e.g., Leconte et al. J Am Chem Soc. 2008; 130(7):2336-2343; U.S. Pat. No. 8,268,978. Some known analogs include 1-methyladenine, 1-methylinosine, 1-methylpseudouracil, 1-methylguanine, 2-methyladenine, 2-methylguanine, 2-thiocytosine, 2-thiocytosine, 2-thiouracil, 2,2-dimethylguanine, 2,6-diaminopurine, 2-methylthio-N6-isopentenyladenine, 3-methylcytosine, 4-acetylcytosine, 4-thiouracil, 5-bromouracil, 5-carboxymethylaminomethyl-2-thiouracil, 5-(carboxyhydroxylmethyl) uracil, 5-carboxymethylaminomethyluracil, 5-fluorouracil, 5-methylcytosine, 5-methoxyuracil, 5-methylaminomethyluracil, 5-methyl-2-thiouracil, 5-methyluracil, 5′-methoxycarbonylmethyluracil, 5-methoxyaminomethyl-2-thiouracil, 7-methylguanine, 8-hydroxy-N6-methyladenosine, aziridinylcytosine, beta-D-mannosylqueosine, dihydrouracil, inosine, N6-isopentenyladenine, N6-methyladenine, N-uracil-5-oxyacetic acid methylester, oxybutoxosine, pseudoisocytosine, pseudouracil, pseudouracil, queosine, uracil-5-oxyacetic acid, uracil-5-oxyacetic acid methylester, and uracil-5-oxyacetic acid etc. Many nucleotide analogs are commercially available through suppliers such as Sigma and Applied Biosystems.

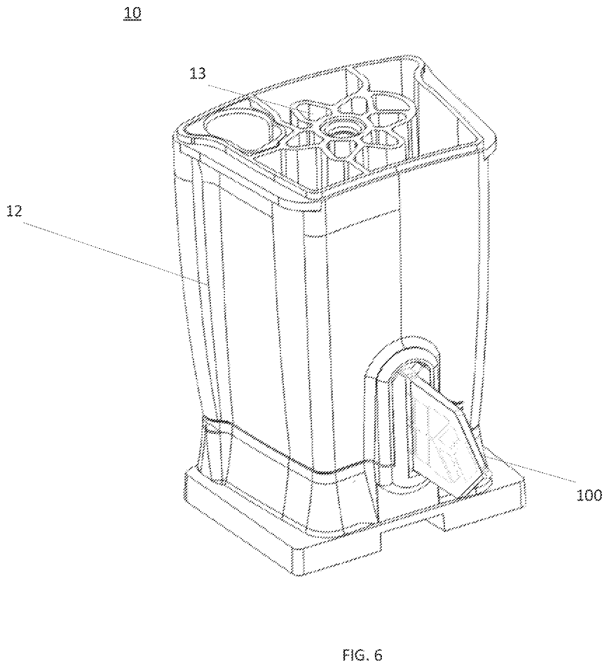

FIG. 6 shows a fluid control and processing cartridge 10 including a housing 12 having a plurality of chambers 13. An internally located fluid control device (not shown) and the reaction vessel 100 are connected to different portions of the housing 12. The cartridge 10 provides the reaction vessel with sample fluid and other fluids as necessary, by fluidically coupling with the fluidic interface 108. Typically, the cartridge comprising the reaction vessel is used in a GeneXpert® system by Cepheid® of Sunnyvale, Calif., U.S.A. In some embodiments, the cartridge comprising a reaction vessel is used in one or more modules of a heterogenous system as disclosed in U.S. Pat. App. Ser. No. 61/639,820 incorporated by reference and attached hereto as part of Appendix A. Additional details of the system 10 and methods for use are described in U.S. Pat. Nos. 8,048,386, 8,187,557, 8,119,352, and U.S. Pub. No. 2008-0038737, each of which is incorporated by reference herein, and attached hereto as Appendix A. In this embodiment, designed for use with the reaction vessel described herein, two of the available 11 chambers of the cartridge are taken up by oils. In some embodiments, reagents (e.g. beads) are stored in one or more remaining chambers. In some embodiments, the base of the cartridge at which the flange of the fluidic interface attaches is designed for a snap-fit interface that readily receives and fluidically couples the reaction vessel to the completed sample cartridge. In conventional cartridges designs, the reaction vessels are attached during assembly of the sample cartridge and cannot be readily removed. By providing a snap-fit interface within the base of the sample cartridge, the high-level multiplex reaction vessel can be attached to select sample cartridge as needed after assembly, thereby providing greater versatility and efficiency in allowing use of a cartridge for both standard assays and highly multiplexed assays.

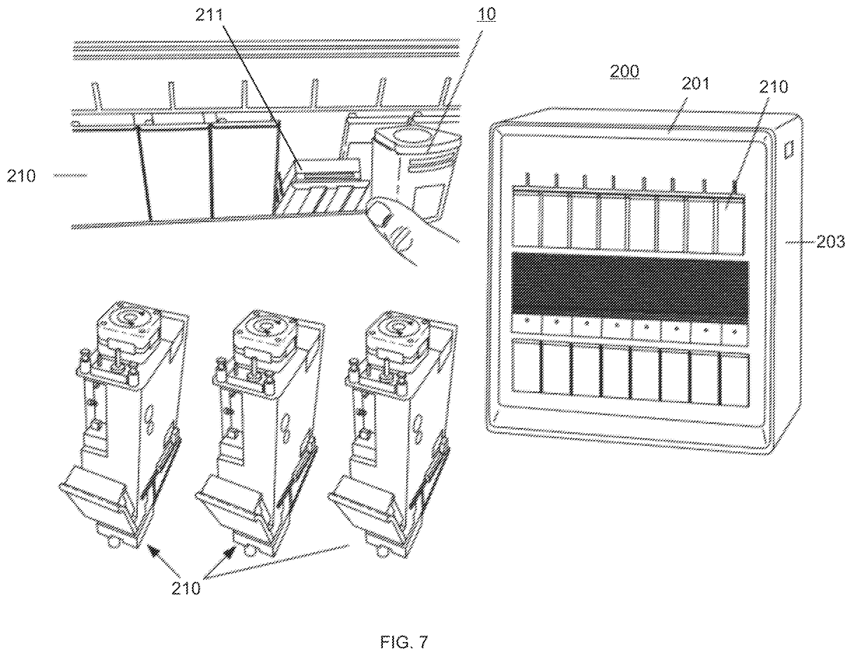

FIG. 7 shows a system 200 having multiple assay modules 210 disposed within an enclosure 201 having a common housing 203. This system includes eight modules, although it is appreciated that the system could include any number of modules. Each module 210 is configured with a door 211 that opens to receive (either manually or robotically) a sample cartridge 10, such as that shown in FIG. 6. The modules 210 are shown in the lower-left view removed from the housing enclosure. Each module 210 includes the instrument core assembly with components (mechanical and optical elements/sensors) for processing/testing a fluid sample in the sample cartridge. It is appreciated that one or more modules of the system can be configured to process a high-level multiplexing reaction vessel, such as any of those described herein. The system can further include one or more conventional modules that are configured to process a lower-level multiplex reaction vessels, such as those of conventional reaction vessels.

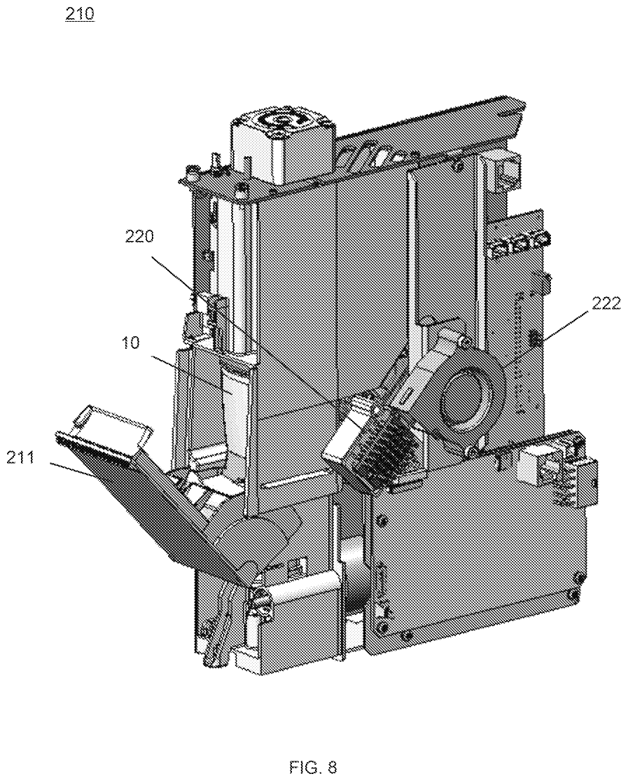

FIG. 8 shows a detailed view of a module 210 configured for high-level multiplexing removed from the system enclosure. The module includes a thermal cycling unit 220 that includes blower fan 225 for thermal cycling the fluid sample in the pre-amplification chamber of the high-level multiplexed reaction vessel. The assembly also includes an optical detector (not shown) adjacent a major face of the reaction vessel to allow for detection of reaction that are spatially separated on the array. Thus, unlike the conventional modules in the GeneXpert® platform, these modules allow for thermocycling and detections in an array of PCR wells in a highly multiplexed reaction vessel. The module includes an instrument core assembly that represents a scalable solution for analysis of highly multiplexed samples. In this embodiment, the module allows for at least two simultaneous reactions per well (e.g., a target and a control). In some embodiments, the module is capable of operation alongside conventional modules in a standard instrument housing. The modules include flexible connectivity and software to facilitate thermal cycling and analytical testing of a highly-multiplexed reaction tube. In some embodiments, this represents a scalable architecture that can be scaled to accommodate various levels of multiplexing. By this approach, existing analytical testing systems can be retrofitted with one or more improved modules capable of use with high-level multiplexing reaction vessel, so that the system can efficiently provide the full range of available assays.

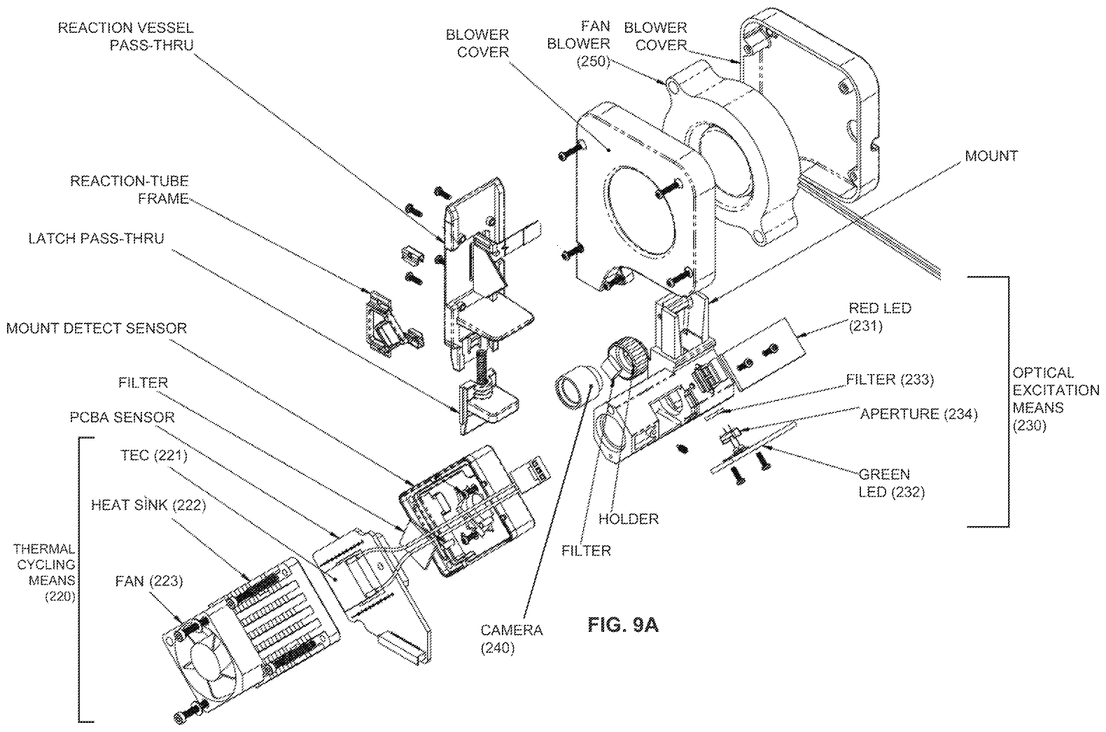

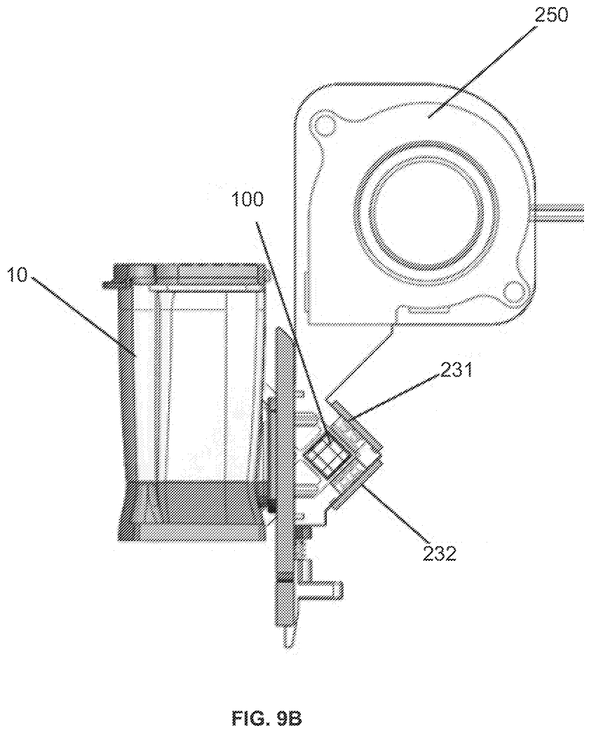

FIG. 9A shows an exploded view of select components of the instrument core assembly of the module in FIG. 8. The instrument core includes a thermal cycling assembly 220 that includes heater 224 and a fan blower 225 with blower covers 226a, 226b and a TEC assembly 220A that includes TEC 221, heat sink 222 and heat sink fan 223, an optical excitation means 230 that includes red LED 231 and green LED 232 (which can each include a filter 233 and aperture 234), and an optical sensor that includes lens 240. Here, the instrument is configured for single-sided heating that controls the temperature of the reaction vessel for thermal cycling of the fluid sample, which leaves the opposite side of the reaction vessel available for optical detection by the optical sensor, which can include a photo-diode or camera. The optical excitation means include two-color imaging, one color being a target channel (e.g. green light), and the other channel being a control channel (e.g. red light). In some embodiments, the target channel uses red light while the control channel uses green light. It is appreciated that some embodiments can utilize various other colors for the target and control, or can utilize additional colors for additional targets as well. By this approach, the control allows the user to determine which wells can be relied upon for testing, and the target channel indicates how many of these wells indicate a reaction corresponding to the target detection. In some embodiments, this instrument core is configured to snap into a module and replace the conventional instrument core, thereby allowing conventional modules to be retrofitted to accommodate high-level multiplexing. In some embodiments, the placement of the optical sensor adjacent the major face of the planar reaction vessel requires additional space such that the retrofit module may require additional width within the system, for example, a high-level multiplexing module may occupy the space of two conventional modules. In addition, the high-level multiplexed modules may require use of a new gateway.

FIG. 9B shows a side view of the high-level multiplexing reaction vessel 100 attached to sample cartridge interacting with the red LED assembly 231 and green LED assembly 232 disposed along the upper and lower edges of the well chamber.

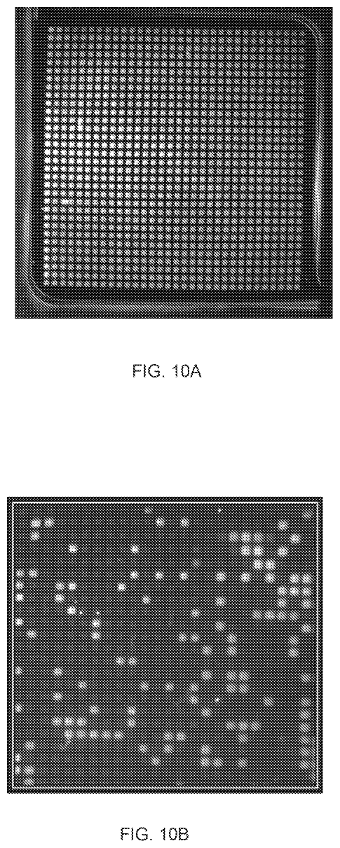

FIG. 10A shows a photograph of a high-level multiplexing array of a reaction vessel 100, in which each well has been filled with fluid sample for analytical testing. As shown, this is a 32 by 32 array with 1024 wells suited for high-level multiplexing.

FIG. 10B shows an image of the luminescence from reactions in select wells of the high-level multiplexing array in FIG. 10 during analytical testing, indicating which target analytes were detected. Such a photograph can be obtained by the optical sensor of the instrument core through the first substrate of the reaction vessel and analyzed to determine which wells indicated reaction correspond to select analytes. In this example, all the wells were filled with the same sample mixture but only some of the wells contained at least one copy of the target in order to start the reaction. In some embodiments, the system may obtain multiple photographs, each photograph corresponding to optical excitation at a differing range of wavelengths. For example, this photograph may represent luminescence from excitation of a particular range of wavelengths (e.g., excitation from a red LED), and another image may be obtained during excitation in another range (e.g. from a green LED). This images can be obtained simultaneously or in rapid succession. In some embodiments, the system obtains two images per PCR thermal cycle, one image for green excitation and one image for red excitation. Collecting a set of images for each thermal cycle allows for tracking of each individual well's PCR curve as a function of cycle number. Advantageously, this provides the capability to perform panels of test that detect a large number of target analytes with a single test, for example, flu panels or cancel signature assays, as described further in the example below.

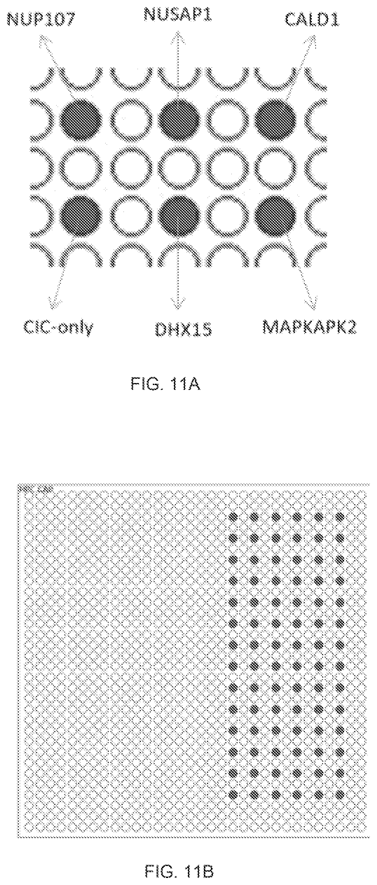

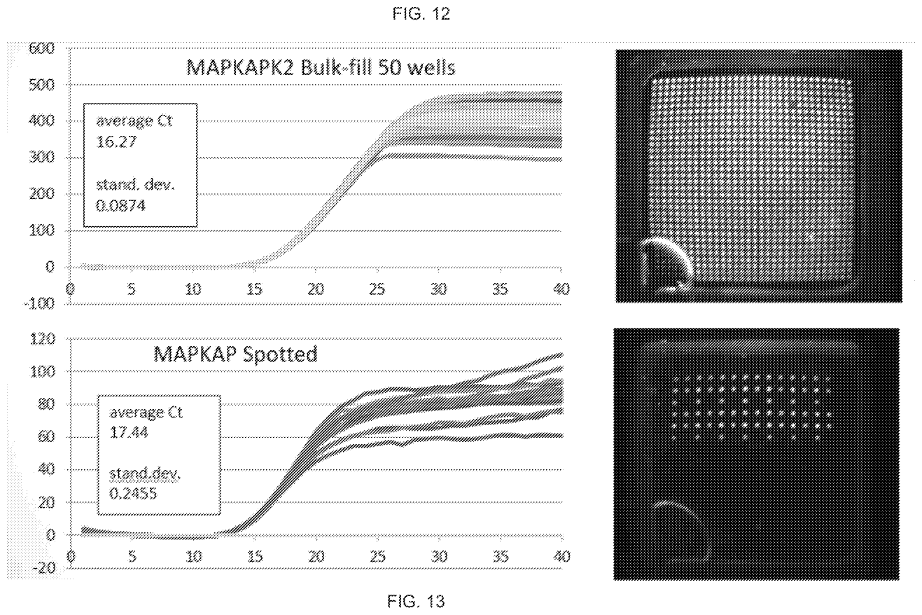

FIGS. 11A-11B depict a breast cancer signature assay. In this assay, there are 20 marker targets for detection, namely, CYFIP-1, TOP2A, EBP, CYFIP-5, NUP107, DHX15, FMOD, DTX4, RACGAP, SYNE2, SUPT4, PRC1, NUSAP1, FADD, TXNIP, CCNB2, CALD1, APOC1, AP1AR, and MAPKAPK2. To simplify analysis and debugging, the assay is broken into separate 5-target combinations, plus a CIC control. Each reaction vessel is patterned with a particular combination (plex). This pattern is repeated 14 times per reaction vessel, or more if desired. A bulk fill (all wells filled with same PCR) with no spotting can be run for comparison, as shown in FIGS. 12 and 13, where FIG. 12 depicts the bulk-fill performance and FIG. 13 depicts the spotted PCR performance.

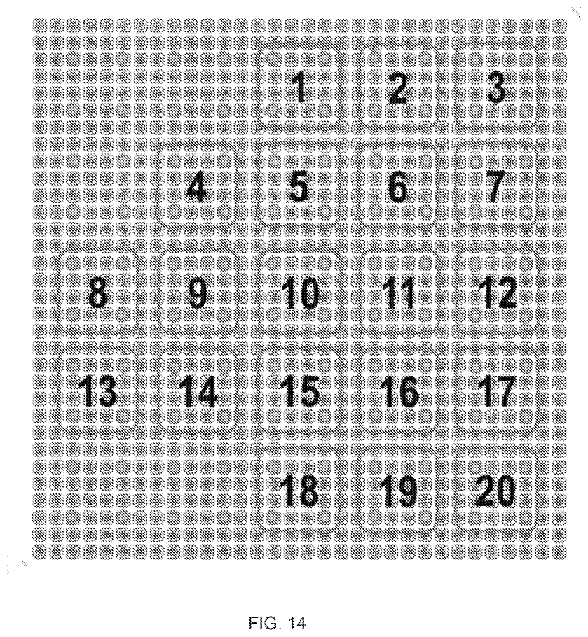

The spotting can be arranged in any suitable pattern desired. FIG. 14 shows an example of a 20 target pattern, which can be used for the breast cancer panel. This pattern can support 25 target in a 5 by 5 grid. There are 4 replicates for each target. Primer-probe sets are spotted at 400 nM each. Experimental results indicated that integration of pre-amplification and in-well PCR resulted in 15 out of 20 spotted target being positive. Experiment results indicated that the entire assay can be run in 145 minutes (time on-board the reaction vessel), which is expected can be further optimized to about 100 minutes, which is considerably more time efficient than many current breast cancer signature panels run by conventional approaches.

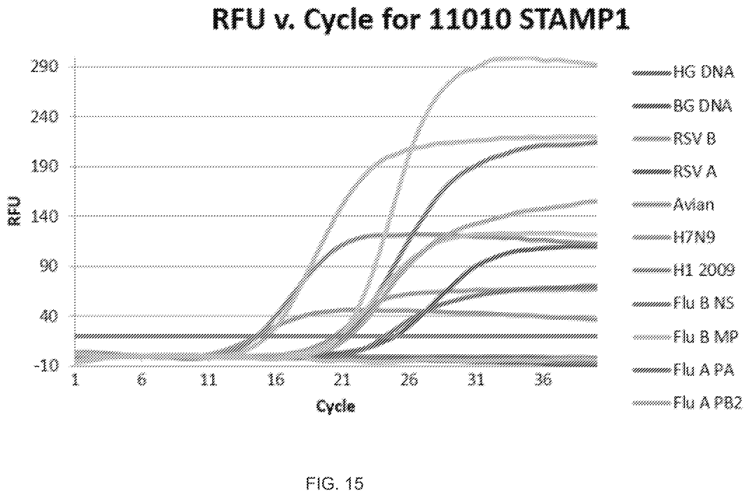

FIG. 15 illustrates another example of a flu panel. Experimental results with spotted reaction vessels indicated acceptable results demonstrating feasibility of performing a flu panel as well.

VI. Chemistry of Well Spotting

In yet another aspect, the invention pertains to improved spotting of reagents within the wells that are particularly suited for user with the high-level multiplexed reaction vessels described herein. The purpose of the template specific reagent (TSR) well matrix chemistry is to retain the specific reagents (e.g. primers and probes) within each well required for real-time PCR detection. The wells must retain the spotted reagents within each well during filling of the wells and well chamber with fluid sample, but must also release the reagents after oil isolation to allow for real-time PCR detection. The general approach chosen is to pre-dispense (or “spot”) the TSR reagents into each well during manufacturing (before film sealing) to dictate which analytes that the reaction vessel will detect. This chemistry may then be dried, heated, and/or cured to maintain the reagent in place during handling & processing. Generally, the only PCR reagents dispensed into the wells will be primers and probes; enzyme, salts, dNTPs, and all other reagents required for real-time PCR are typically be supplied in liquid form from the sample.

The TSR matrix chemistry needs to be chosen carefully to ensure reconstitution does not occur too soon during the well sample filling process to avoid chemical/reagent crosstalk. However, the matrix chemistry must also allow release of the primers/probes into the bulk liquid of each well after oil isolation in order to allow real-time PCR to occur. The amount of chemical/reagent crosstalk must be low enough so as not to significantly compete with the designated well PCR reaction, estimated to be <25% into the nearest neighbor well during sample filling & oil isolation.

In addition, the well matrix chemistry must not significantly inhibit or interfere with real-time PCR (either chemically or optically), must be manufacturable (a liquid sample for facile dispensing is preferred), and must be stable over time after spotting at least up to 9 months when stored at 2-8° C.

It was observed during early spotting development that material spotted inside the wells leaches out and washes away during the well sample filling and oil isolation steps. A method to retain spotted material (primers/probes) inside the wells during filling is essential for the subsequent real-time PCR reaction. While maintaining the spotted material inside the wells (filling retention) is important, it is equally essential to be able to release the primers/probes from the spotting matrix (in-well PCR performance), to allow for sample mixing within each well for in-well real-time PCR to take place.

Three major screening criteria used to determine the most suitable chemical reagents, were as follows: 1) The spotting matrix must be able to retain the majority of the spotted material inside the wells during the well filling and oil isolation steps; 2) The spotting matrix must be able to release the spotted materials after individual well oil isolation, to allow for same mixing within the well; and 3) The spotting matrix must be in compatible with in-well real-time PCR (i.e. it must be non-inhibitory both chemically and optically).

Four minor criteria that were used to determined the most suitable chemical reagents were as follows: 1) The spotting chemistry matrix must be easy to formulate for ease of manufacturability, with the flexibility to be made in-house or out-of-house with a minimal amount of equipment required; 2) The preparation of the spotting matrix must be minimally complex with a minimal number of chemical components and additives, along with simple processing step(s); 3) The matrix chemistry must be easy to spot using the manual spotting system, bearing in mind the chemical and physical properties that impede spotting. Properties such as viscosity, gelation, evaporation, and special storage requirements during the spotting process must be taken into consideration; and 4) The matrix chemistry should have minimal and simple secondary processing steps (e.g., drying, curing).

Also considered were three less critical criteria, which were as follows: 1) The cost of the raw chemical material and manufacture of the spotting matrix should be optimized for cost; 2) The raw chemical material should be procured from non-animal origin to minimize interferences with regulatory restrictions; and 3) The raw chemical material and its byproducts should be nontoxic and non-carcinogenic to minimize health hazardous effects on operator and personnel who handle the material.

VII. Overview of Well Chemistry Matrix Studies

In one aspect, matrix materials that are suitable for mixing with chemical reagents that may be compatible for the filling and PCT techniques associated with the reaction vessel described herein can include: 1) polymer type materials; 2) paramagnetic particles; 3) polymer and paramagnetic particle species.

Various matrix materials and classes of materials were considered and analyzed in extensive experimental studies under conducted under various conditions. The matrix materials considered included but not limited to: HEC (Hydroxyethyl cellulose), NIPAM (n-isopropylacrylamide), PVA (Poly Vinyl Alcohol), Agarose, Methyl Cellulose, HPMC (Hydroxypropyl) methyl cellulose, PEG (Polyethylene Glycol), Particles HPC (Hydroxypropyl cellulose), CMC (Sodium carboxymethyl cellulose), Glycerol, Sucrose, Trehalose, BSA (Bovine Serum Albumin), SPA (Sodium Polyacrylate), Cepheid Universal Lyophilization Buffer Polyacrylamide, DNA stabilizer Kit, Pullulan Alginate+Calcium Chloride, Wax, 1-Tetradecanol, Pectin, TMOS (Tetramethyl orthosilicate), Palmitic acid, Pluronic, Ficoll, Gelatin, PVP, Gantrez, and mixtures thereof.

In applying the screening procedure developed above, it was determined that HEC (Hydroxyethyl cellulose), NIPAM (n-isopropylacrylamide) and Hydroxypropyl cellulose (HPC) were the most suitable substances for mixing with the reagents and spotted in the wells. Both HEC and NIPAM provided suitable retention performance during filling of the wells according to the desired criteria. HEC, in particular, provided the desired retention performance during filling of the wells and additionally demonstrated desirable in-well PCR performance.

Of the polymer type materials, water-soluble polymers are preferred such that introduction of the fluid sample releases the reagent within the material. Suitable such materials can include, but are not limited to: cellulose, or derivatives or variants of cellulose; acrylamide or derivatives or variants of acrylamide; agarose or derivatives or variants of agarose; alcohols or derivatives or variants of alcohol; poly(ethylene glycol) or derivatives or variants of poly(ethylene glycol) or mixtures thereof.

Of the paramagnetic particles, these materials are weakly drawn to the poles of a magnet, but are not themselves magnetic. Bead-based molecular assay has been shown in the literature for decades & are available in numerous on-market products (e.g., Gen-Probe/Hologic). Polystyrene particles may be functionalized with reactive groups to capture/retain primers/probes, and the reactive groups may then be cleaved to release the captured primers/probes. Alternately, primers/probes may be non-specifically adsorbed and then release from the surface of particles.

In was envisioned that the TSR oligos may be attached to particles and spotted in a matrix chemistry, wherein the matrix chemistry may entrap the relatively larger particles. Moreover, the use of paramagnetic particles in combination with a magnet placed within the reaction vessel module behind the wells may help retain the particles in each well. Paramagnetic Polystyrene (PS-MAG) and Silica microparticles (SiO2-MAG), with a diameter of 3.9 μm and 7.52 μm respectively, were obtained from Microparticles GmbH for testing as a physical retention mechanism in wells. These particles were be coated with target specific reagents either through adsorption or via a functionalized surface and held in place in wells via a magnet placed within the reaction vessel module. However, this approach demonstrated inconsistency in spotting and carryover between wells was observed.

Of the polymer and paramagnetic particle species, the preferred materials exhibit the advantages of polymer materials as well as those of paramagnetic materials. Suitable materials can include, but are not limited to: HEC-(Hydroxyethyl cellulose); NIPAM-(n-isopropylacrylamide); PVA-Polyvinyl Alcohol; Agarose; Methyl Cellulose; HPMC-(Hydroxypropyl) methyl cellulose; PEG-(Polyethylene glycol); Particles-(Paramagnetic); HPC-(Hydroxypropyl cellulose); and mixtures thereof.

In some embodiments, chemical reagents within HEC material demonstrated superior performance in regard to retention during filling as well as in-well PCR performance. The following characteristics were determined from the extensive studies and experiments conducted:
Molecular Weight (MW)-90K-1,300K Daltons (preferably having a MW 720K)
Concentration 1-2% (preferably 2%)
Drying Conditions—70° C.-105° C. from 1-6 days (HEC performance was optimized at 90° C., for 24 hours

Based on the various spotting matrix screening criteria and series of testing, the 2% HEC (MW 720k) solution has continuously and successfully demonstrated its spot retention and release properties, while not interfering or inhibiting with in-well PCR. MW 720k HEC is therefore considered particularly advantageous for use as a well spotting matrix.

As demonstrated in the extensive studies undertaken to determine the most suitable reagent matrix materials, it was noted that HEC had marked advantages over the other proposed matrix materials, which included: i) HEC can be spotted into multiple wells without disruption; ii) Spotted HEC remains physically intact, demonstrates acceptable retention of TSR, and shows limited leaching of HEC when wells are filled with the fluid sample mixture; (iii) spotted TSR in HEC releases and interacts with target in the mastermix; (iv) PCR activity can be measured in the oil isolated HEC spotted in a well; (v) carryover contamination, or endpoint fluorescent signal due to chemical crosstalk into non-spotted wells, is minimal relative to endpoint PCR signal among spotted wells.

Extensive experimental demonstrated that HEC exhibiting characteristics that provided significant advantages over conventionally used reagent matrices. In particular, HEC exhibited suitably delayed water solubility to ensure that the spotted reagent remained trapped within the matrix during initial filling of the well, thereby ensuring integrity of the chemistry of the well for suitable PCR performance as well as avoiding cross-contamination with adjacent wells. HEC further exhibited desired water solubility after a minimum exposure time, which ensured that the reagents were suitably released into the fluid sample after isolation of each well to ensure satisfactory in-well PCR performance. Additionally, HEC provided the additional advantage of exhibiting cross-linking when heated, which caused the matrix to maintain integrity for a longer duration when exposed to water. This property can be utilized by heating the reaction vessel during filling to further improve integrity of the matrix during filling and/or delay the breakdown of the matrix upon exposure to the fluid sample until the wells are isolated. Experimental results also indicated desirable characteristics in regard to retention during filling of the wells, but also indicated the need for further development in regard to in-well performance.

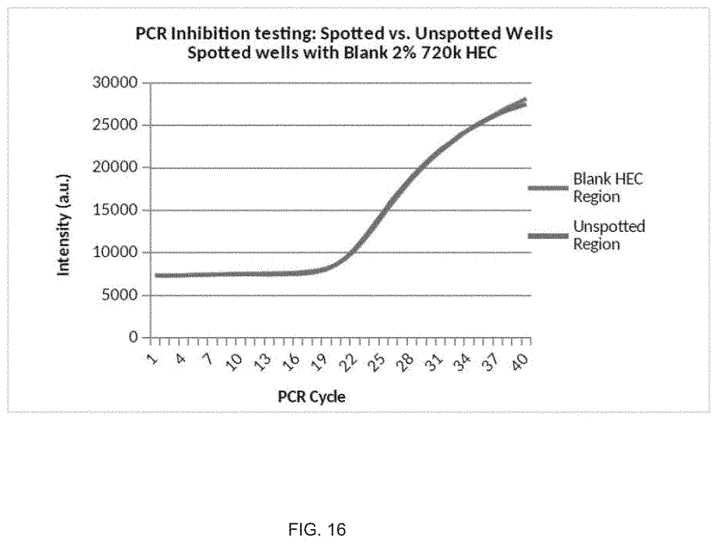

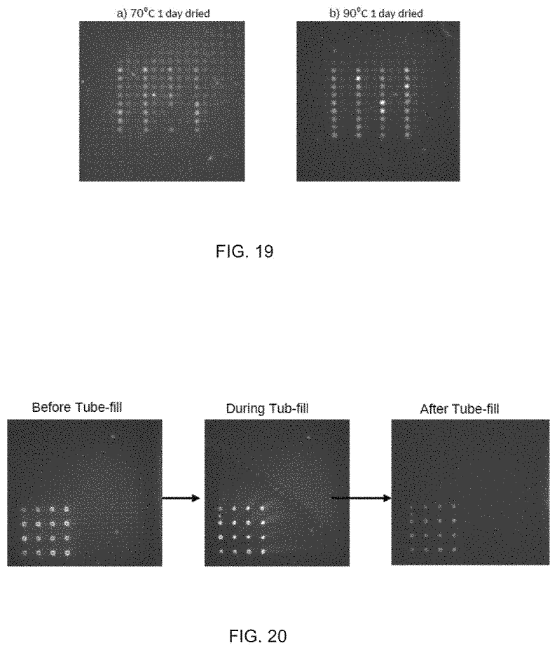

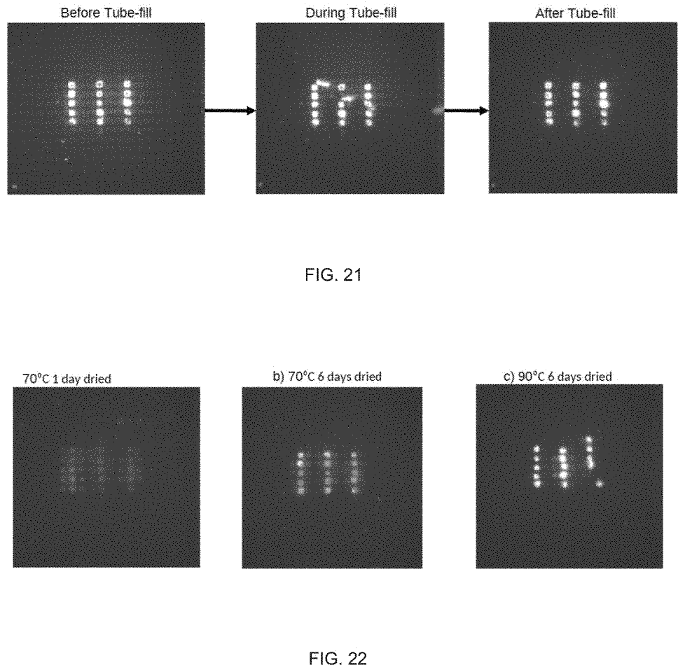

Experimental result as to the performance of HEC as a matrix material are shown in FIGS. 16-22. As can be seen, 2% HEC exhibited characteristics most suited for the presently described spotting application and exhibited performance that far exceeded a multitude of alternative matrix materials. FIG. 17 shows reaction vessel fill observations of 2% HEC solution; FIG. 18 shows post-fill images during fill retention testing when dried at a) 70° C. for 1 day b) 70° C. for 6 days and c) 90° C. for 1 day and d) 90° C. for 6 days; FIG. 19 shows post-fill images capture during retention testing of 2% HEC; FIG. 20 shows spot retention testing of 1% HEC dried at 105° C. for 1 day; FIG. 21 shows fill testing of 2% HEC cap over bottom layer of 2% HEC dried at 90° C. for 6 days; and FIG. 22 shows post fill images of 2% HEC capped samples dried at a) 70° C. for 1 day, b) 70° C. for 6 days and c) 90° C. for 6 days.

All patents, patent applications, and other publications, cited in this application are incorporated by reference in the entirety for all purposes.

1. A reaction vessel comprising:
a planar frame defining a fluidic path between a first planar substrate and a second planar substrate; and
a fluidic interface at one end of the planar frame, the fluidic interface comprising a first fluidic port and a second fluidic port, wherein the fluidic path extends between the first and second fluidic ports;
wherein the fluidic path further includes a well chamber having a plurality of wells, arranged in the planar frame between the first and second substrates, the well chamber disposed along the fluidic path nearer the first fluidic port than the second fluidic port; and
a pre-amplification chamber arranged in the planar frame between the first and second substrate and disposed along the fluidic path nearer the second fluidic port than the first fluidic port.

2. The reaction vessel of claim 1, wherein the fluidic path includes one or more valves disposed between the pre-amplification chamber and the well chamber.

3. The reaction vessel of claim 1, wherein the fluidic path further includes a serpentine passage between the pre-amplification chamber and the well chamber.

4. The reaction vessel of claim 3, wherein the fluidic path further includes an intermediate passage extending from the serpentine channel toward to the well chamber, wherein the intermediate passage slopes downward toward the well chamber.

5. The reaction vessel of claim 4, wherein the fluidic path further includes a fluidic path valve between the serpentine passage and the well chamber.

6. The reaction vessel of claim 5, wherein the fluidic path further includes an oil chamber in fluid communication with a downstream portion of the intermediate passage, the oil chamber dimensioned and configured for trapping oil flowing from the serpentine channel toward the well chamber.

7. The reaction vessel of claim 6, wherein the oil chamber further includes an oil trap valve.

8. The reaction vessel of claim 1, wherein a pre-amplification chamber exit is positioned at an upper-most portion of the pre-amplification chamber when the first and second planar substrates are vertically orientated with the first fluidic port below the second fluidic port.

9. The reaction vessel of claim 8, wherein the fluidic path includes a well chamber entrance positioned at a lower-most portion of the well chamber.

10. The reaction vessel of claim 9, wherein the fluidic path includes an inlet passage extending from the first fluidic port toward the well chamber.

11. The reaction vessel of claim 10, wherein the inlet passage is substantially horizontal.

12. The reaction vessel of claim 11, wherein the well chamber entrance between the inlet passage and well chamber slopes upward toward the well chamber.

13. The reaction vessel of claim 1, wherein the fluidic path includes one or more valves that comprise constrictions such that fluid flow along the fluid path can be affected by varying pressure through either of the first and second fluidic ports.

14. The reaction vessel of claim 1, wherein the well-substrate comprises 100-2000 wells.

15. The reaction vessel of claim 14, wherein the well-substrate comprises a plurality of wells having a depth of about 100 to about 500 μm.

16. The reaction vessel of claim 14, wherein the well-substrate comprises a plurality of wells having a diameter of about 50 to about 500 μm.

17. The reaction vessel of claim 14, wherein each of the plurality of wells have a volume within a range of about 0.5 to about 2 nL.

18. The reaction vessel of claim 1, wherein the second planar substrate is integrally formed or molded with the planar frame.

19. The reaction vessel of claim 18, wherein the first planar substrate comprises a thin film that fluidically seals against the planar frame.

20. The reaction vessel of claim 1, wherein the planar frame is fluidically connected to a sample container via the fluidic interface.

21. The reaction vessel of claim 1, wherein the plurality of wells are spotted with one or more reagents mixed with a matrix material in liquid form, wherein the reagent and matrix material mixture is dried or baked into a solid form.

22. The reaction vessel of claim 1, wherein differing wells are spotted with differing reagents to facilitate detection of differing targets within the same reaction vessel.

23. The reaction vessel of claim 1, wherein the plurality of wells are spotted with a plurality of reagents to facilitate detection of 10 or more targets.

24. The reaction vessel of claim 1, wherein the plurality of wells are spotted with a plurality of differing reagents in differing groups that are spatially separated to facilitate identification of differing reactions in the differing groups.

25. The reaction vessel of claim 24, wherein the differing groups are spotted in a repeating pattern to facilitate identification of the differing reactions in the differing groups.

26. The reaction vessel of claim 1, wherein the plurality of wells are spotted with a plurality of reagents that are mixed with a water-soluble matrix material.

27. The reaction vessel of claim 26, wherein the matrix material comprises a polymer that degrades or dissolves upon exposure to water for a minimum duration of time, wherein the polymer remains intact until that minimum duration of time.

28. The reaction vessel of claim 27, wherein the minimum duration of time is any of: 10 seconds, 15, seconds, 20 seconds, 30 seconds, one minute or more.

29. The reaction vessel of claim 27, wherein the matrix material comprises a polymer that cross-links when heated so that heating of the matrix material facilitates prolongs the integrity of the polymer after exposure to water.

30. The reaction vessel of claim 1, wherein the matrix material comprises any of: HEC, NIPAM and HPC.

31.-101. (canceled)
